(19) United States
(12) Patent Application Publication
(10) Pub. No.: US 2026/0196102 A1
(43) Pub. Date: Jul. 9, 2026

(54) Devices, Processes and Systems for Facilitating Multi-Jackpot Games

(71) Applicant: DK Crown Holdings Inc., Boston, MA (US)

(72) Inventors: Joseph Roland Beaulieu, Harvard, MA (US); Joseph Michael Nissim Behar, San Francisco, CA (US); Yom F Woldemichael, Schuyler Lake, NY (US); Chenyu Sun, Woodridge, IL (US); Daniel Maistern, Holon (IL); Michael James Powell, Phoenixville, PA (US); Daniel Sun, Marion, IA (US); Gary J Springer, Jr., Bend, OR (US)

(73) Assignee: DK Crown Holdings Inc., Boston, MA (US)

(21) Appl. No.: 19/416,410

(22) Filed: Dec. 11, 2025

Related U.S. Application Data
(60) Provisional application No. 63/742,133, filed on Jan. 6, 2025.
(60) Provisional application No. 63/742,145, filed on Jan. 6, 2025.

(51) Int. Cl. G07F 17/32

(52) U.S. Cl. CPC G07F 17/3258; G07F 17/3225

(57) ABSTRACT

Devices, systems, processes, and computer readable medium are described for a multi-jackpot game system (MJGS) that includes a player interface service (PIS); a user management service (UMS); a jackpot gamification service (JGS); an online casino game and jackpot transaction service (OCGJTS); and an account management service (AMS). A player device is coupled to these elements which are also variously coupled. The PIS instantiates: a gaming launch engine (GLE) that launches a given online casino game (OCG) on the given player device and facilitates retrieval and updating of data specific to the given OCG; a gaming/jackpot interface engine (GJIE) that manages configuration of the given OCG and presenting a jackpot lobby that identifies at least two available jackpots available for selection by the given player; and an online casino gamine engine (OCGE) that communicates gameplay requests to and from the OCGAS for the given OCG.

### CROSS-REFERENCE TO RELATED APPLICATIONS

The present application claims priority to United States Provisional Patent Application Ser. No. 63/742,133, filed on 6 Jan. 2025, in the name of inventors Joseph Roland Beaulieu et. al., entitled “Devices, Processes and Systems for Facilitating Multi-Jackpot Games,” and further identified by the attorney docket number DK20241206 (DK-00015) (herein, the “DK15 App.”).

The present application claims priority to United States Provisional Patent Application Ser. No. 63/742,145, filed on 6 Jan. 2025, in the name of inventors Jeffrey Williams et. al., entitled “Devices, Processes and Systems for Facilitating Multi-Jackpot Games,” and further identified by the attorney docket number DK20241207 (DK-00016) (herein, the “DK16 App.”).

The present application is related to U.S. patent application Ser. No. ______, filed on 11 Dec. 2025, in the name of inventors Jeffrey Williams et. al., entitled “Devices, Processes and Systems for Facilitating Multi-Jackpot Games,” and further identified by the attorney docket number DK20241207.1 (DK-00026) (herein, the “DK26 App.”).

The entire contents of the DK15 App., the DK16 App., and the DK26 App. are herein incorporated by reference.

### TECHNICAL FIELD

The technology described herein generally relates to devices, systems, and processes for providing multi-jackpot games.

### BACKGROUND

An online casino gaming system (“OCGS”) commonly includes a player device, by which a user (which is also referred to herein as a “player”) receives data regarding one or more online casino style games, makes bets, engages with the game (e.g., by spinning a slot, taking a card, depositing or withdrawing funds, or the like). The player device commonly utilizes one or more application program interfaces, applications, web pages, or the like (herein collectively, “APIs”) that facilitate the “game play” on their chosen player device, with non-limiting examples of player devices including smartphones, tablet computing devices, laptop computers, desktop computers, and the like. The API communicates, with various servers, data regarding casino game selection, wager amount, the player's bet selections (e.g., raise, hold, double down, or the like), the player's “game play” activities (e.g., draw a card, hold, split cards, spin a slot machine wheel, or the like), results of “game play” (e.g., win, lose, etc.), and the like.

The various servers may include “casino game play” servers (which are also referred to herein as “aggregators”), OCGS provider servers and the like. One non-limiting example of an aggregator is International Game Technology (IGT™) based in Reno, Nevada, USA. One non-limiting example of an OCGS provider is DraftKings Inc. of Boston Massachusetts, USA. Aggregators commonly utilize servers, data stores, and the like, which may be Cloud based, or otherwise provided, to facilitate the gaming related aspects of a given online casino game (e.g., the providing of a virtual deck of cards for a blackjack game, the shuffling of the cards, drawing of cards, etc.). Each of such gaming related aspects are referred to herein as each being the providing of a “casino game service” and are typically highly regulated by various governmental entities. The features and functions provided by a given aggregator for any given casino game service are beyond the scope of the present disclosure and any aggregator and/or online casino game may be utilized in conjunction with an implementation of the present disclosure.

As is well known, an OCGS provider commonly provides its online casino gaming services by leveraging, in conjunction with the services provided by one or more aggregators, the distributing data processing, storage, communications and other features of Cloud (as defined herein) providers, such as Amazon Web Services (AWS™). It is to be appreciated that Cloud services commonly utilize multiple servers, data stores, couplings, communications networks, security modules, and the like (as respectively defined hereinbelow and as otherwise collectively referred to herein as “OCGS service”). Utilizing OCGS services, an OCGS provider provides one or more services that facilitate various non-gameplay related activities, such as user verification, game play interfaces, lobby functions, wager, account processing, and the like.

Often, a given online casino game may be associated, by an OCGS provider, with a jackpot. For example, an online casino game, such as HYPER NOVA™, may include game play that is supported by an aggregator and a jackpot that is provided by an OCGS provider, such as DraftKings Inc, under the DRAFTKINGS™ brand. The jackpot enables a player of a given online casino game to seek to receive winnings (i.e., jackpots) greater than a successful single play of the given online casino game would otherwise commonly award. The jackpot may apply across many games and may increase as multiple participants wager bets thereagainst. Numerous types of jackpots may be provided by an OCGS service. For example, and not by limitation, featured jackpots, daily must drop jackpots, must hit by jackpots, multi-level jackpots, single-level jackpots, slot jackpots, table game jackpots, live dealer jackpots, and the like may be provided, at any given time, by an OCGS service. However, today, a player may only select to play, at any given time, and while participating in a given online casino game (e.g., blackjack), a single one of the multitude of jackpots available. In essence the player is technologically prohibited today from participating in multiple, distinct jackpots in association with the playing of a given online casino game.

Accordingly, devices, systems and processes are needed that provide multi-jackpot games in the OCGS environment.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of various implementations of the present disclosure is provided in the following written description and illustrated in the accompanying drawings.

Various implementations are described of devices, systems, and processes for generating fixture specific models and utilizing such fixture specific models during real-time event simulations to generate real-time pricing for one or more betting lines where the real-time pricing accounts for one or more real-time variations in one or more fixtures for the event.

In accordance with at least one implementation of the present disclosure, a system of one or more computers can be configured to perform particular operations or actions by virtue of having software, firmware, hardware, or a combination thereof installed on the system that, in operation, cause(s) the system to perform the actions. One or more computer programs can be configured to perform particular operations or actions by virtue of including instructions that, when executed by a data processing apparatus, cause the apparatus to perform the actions.

In accordance with at least one implementation of the present disclosure, a multi-jackpot game system (MJGS) may include: a player interface service (PIS); a user management service (UMS); a jackpot gamification service (JGS); an online casino game and jackpot transaction service (OCGJTS); and an account management service (AMS). A given player device, utilized by a given player, may be communicatively coupled to the PIS, an online casino gaming aggregator services (OCGAS), the JGS, and the UMS. The PIS may further be respectively communicatively coupled to the OCGAS, the JGS, the OCGJTS, the UMS, and the AMS. The UMS may be further respectively communicatively coupled to the OCGJTS. The JGS may be further communicatively coupled to the OCGJTS. The OCGJTS may be further communicatively coupled to the AMS. The PIS may include: a PIS processor; a non-transitory PIS data store, coupled to the PIS processor, non-transitorily storing PIS computer instructions which, when executed by the PIS processor, instantiate a gaming launch engine (GLE) that performs gaming launch operations (GLO). The GLO may include launching a given online casino game (OCG) on the given player device; and facilitating retrieval and updating of data specific to the given OCG. The PIS processor may also instantiate a gaming/jackpot interface engine (GJIE) that performs gaming/jackpot interface operations (GJIO) including: managing configuration of the given OCG; and presenting a jackpot lobby on the given player device. The jackpot lobby may identify at least two available jackpots available for selection by the given player. The PIS processor may also instantiate an online casino gamine engine (OCGE) that performs OCG operations (OCGO) including communicating gameplay requests to and from the OCGAS for the given OCG.

For at least one implementation of an MJGS, at least one of the at least two available jackpots are available, to the given player device, while the given player device participates in at least one of the given OCG and another OCG.

For at least one implementation of an MJGS, the GLO may further include: identifying one or more OGCs available for the given player to participate in based on a current location of the given player and the GJIO may further include: receiving a request, from the given player device, for jackpot data for at least one of the at least two available jackpots; and receiving a request, from the given player device, to participate in the given OCG and select two or more of the at least two available jackpots.

For at least one implementation of an MJGS, the UMS may include: a UMS processor; and a non-transitory UMS data store, coupled to the UMS processor, non-transitorily storing UMS computer instructions which, when executed by the UMS processor instantiate: a notification engine (NE) that performs NE operations (NEO) including: communicating data provided by one or more of the PIS, the JGS, the OCGJTS, or the AMS to the given player device.

For at least one implementation of an MJGS, the UMS computer instructions, when executed by the UMS processor, may further instantiate: a session engine (SE) that performs SE operations (SEO) including: managing a given gaming session for the given OCG; and generating a user interface, for presentation to the given player device by a gaming/jackpot interface engine instantiated by a PIS processor. The user interface may facilitate at least one of a creation, a validation, an extension, and a termination of the given gaming session by the given player device.

For at least one implementation of an MJGS, the UMS computer instructions, when executed by the UMS processor, may further instantiate: a player validator engine (PVE) that performs PVE operations (PVEO) including managing participation by the given player device in the given gaming session.

For at least one implementation of an MJGS, the UMS computer instructions, when executed by the UMS processor, may further instantiate: a gameplay authenticator engine (GAE) that performs GAE operations (GAEO) including: monitoring gameplay actions for the given OCG; authenticating the gameplay actions; monitoring jackpot actions requested by the given player device with respect to at least one selected jackpot of the at least two available jackpots; and authenticating the jackpot actions.

For at least one implementation of an MJGS, the authenticating of the jackpot actions may be performed by the GAE based on gaming rules specified for the at least one selected jackpot.

For at least one implementation of an MJGS, the JGS may include: a JGS processor; and a non-transitory JGS data store, coupled to the JGS processor, non-transitorily storing JGS computer instructions which, when executed by the JGS processor, instantiate: a jackpot gaming engine (JGE) for the at least two available jackpots. The JGEs may perform jackpot operations (JO) including: receiving, from the PIS, an acceptance of a given jackpot selected, by the given player device, from the at least two available jackpots. The acceptance may include a plurality of wagers placed by the given player device including: a first wager for a gameplay turn in the given OCG; a second wager for a first jackpot of the at least two available jackpots; and a third wager for a second jackpot of the at least two available jackpots.

For at least one implementation of an MJGS, the OCGJTS may include: an OCGJTS processor; and a non-transitory OCGJTS data store, coupled to the OCGJTS processor, non-transitorily storing OCGJTS computer instructions which, when executed by the OCGJTS processor, instantiate: a rewards engine (RE) that performs RE operations (REO) including: processing a reward arising from gameplay for at least one of the given OCG and at least one of the at least two available jackpots; and a credit engine (CE) that performs CE operations (CEO) including: processing a credit transaction arising from the gameplay for at least one of the given OCG and at least one of the at least two available jackpots.

For at least one implementation of an MJGS, the OCGJTS may include: an OCGJTS processor; and a non-transitory OCGJTS data store, coupled to the OCGJTS processor, non-transitorily storing OCGJTS computers instructions which, when executed by the OCGJTS processor, instantiate: a jackpot event engine (JEE) that performs JEE operations (JEEO) including: storing data regarding a jackpot event for at least one of the at least two available jackpots; and a transaction queuing engine (TQE) that performs TQE operations (TQEO) including: receiving jackpot event data indicative of a jackpot event for at least one of the at least two available jackpots; and using an ordered data structure to manage processing of the jackpot event data when the jackpot event data is received in an asynchronous order.

For at least one implementation of an MJGS, the OCGJTS may include: an OCGJTS processor; and a non-transitory OCGJTS data store, coupled to the OCGJTS processor, non-transitorily storing OCGJTS computers instructions which, when executed by the OCGJTS processor, instantiate: a jackpot integration engine (JIE) that performs JIE operations (JIEO) including: integrating an online casino platform with a jackpot platform. The online casino platform may facilitate gameplay, by the given player via the given player device, for the given OCG; and the jackpot platform may facilitate presentation of the at least two available jackpots to the given player via the given player device. The JIE operations may further include negotiating an authentication token for use in the given OCG and at least one of the at least two available jackpots.

For at least one implementation of an MJGS, OCGJTS computer instructions, when executed by the OCGJTS processor, may instantiate: a jackpot messaging engine (JME) that performs JME operations (JMEO) including: communicating an OCG result arising from gameplay for the given OCG to the JGS. The JGS may determine whether the OCG result qualifies as a winning gameplay for a selected jackpot of the at least two available jackpots in which the given player has selected to participate. The JMEO may also include receiving a jackpot won notification from the JGS when the given player device has won the selected jackpot; and communicating the jackpot won notification to the AMS.

For at least one implementation of an MJGS, the AMS may include: an AMS processor; and a non-transitory AMS data store, coupled to the AMS processor, non-transitorily storing AMS computer instructions which, when executed by the AMS processor, instantiate: a wallet ledger engine (WLE) that performs wallet ledger engine operations (WLEO) including maintaining an account record for the given player; a rewards ledger engine (RLE) that performs rewards ledger engine operations (RLEO) including maintaining a reward record for the given player; and a bet history engine (BHE) that performs bet history engine operations (BHEO) including maintaining a bet history for the given player that includes data regarding bets placed and results thereof for any OCGs and for any jackpots in which the given player has participated.

In accordance with at least one implementation of the present disclosure, a multi-jackpot game system (MJGS) may include: a player interface service (PIS); a user management service (UMS); a jackpot gamification service (JGS); an online casino game and jackpot transaction service (OCGJTS); and an account management service (AMS). The PIS may facilitate presentation on a given player device of data regarding an online casino game (OCG) and at least two or more available jackpots associated with the OCG. The UMS may facilitate communication of additional data from the JGS, OCGJTS and AMS to the given player device. The JGS may facilitate gameplay regarding the at least two or more available jackpots. The OCGJTS may facilitate record keeping based on results arising from OCG gameplay and selected jackpot gameplay. The AMS may facilitate accounting for gameplay results for the OCG gameplay and selected jackpot gameplay.

For at least one implementation of an MJGS, the PIS may include: a gaming launch engine (GLE) that performs gaming launch operations (GLO). The GLO may include: launching a given online casino game (OCG) on the given player device; and facilitating retrieval and updating of data specific to the given OCG. Th PIS may instantiate a gaming/jackpot interface engine (GJIE) that performs gaming/jackpot interface operations (GJIO). The GJIO may include: managing configuration of the given OCG; and presenting a jackpot lobby on the given player device. The jackpot lobby may identify at least two available jackpots for selection by the given player. The PIS may also instantiate an online casino gamine engine (OCGE) that performs OCG operations (OCGO) including: communicating gameplay requests to and from the OCGJTS for the given OCG.

For at least one implementation of an MJGS, the JGS may include: a jackpot gaming engine (JGE) that is instantiated by a JGS processor for the at least two available jackpots. For at least one implementation, the JGEs ma perform jackpot operations (JO) including: receiving, from the PIS, an acceptance of a given jackpot selected, by the given player device, from the at least two available jackpots. The acceptance may include a plurality of wagers placed by the given player device including: a first wager for a gameplay turn in the given OCG; a second wager for a first jackpot of the at least two available jackpots; and a third wager for a second jackpot of the at least two available jackpots.

For at least one implementation of an MJGS, the OCGJTS may include: a jackpot integration engine (JIE) that integrates an online casino platform with a jackpot platform. The online casino platform may facilitate gameplay, by the given player via the given player device, for the given OCG. The jackpot platform may facilitate presentation of the at least two available jackpots to the given player via the given player device.

For at least one implementation of an MJGS, the OCGJTS may include: a jackpot event engine (JEE) that stores data regarding a jackpot event for at least one of the at least two available jackpots; and a transaction queuing engine (TQE) that receives jackpot event data indicative of a jackpot event for at least one of the at least two available jackpots and utilizes an ordered data structure to manage processing of the jackpot event data when the jackpot event data is received in an asynchronous order.

For at least one implementation of an MJGS, the AMS may include: a wallet ledger engine (WLE) that maintains an account record for the given player; a rewards ledger engine (RLE) that maintains a reward record for the given player; and a bet history engine (BHE) maintains a bet history for the given player. The bet history may include data regarding bets placed and results thereof for any OCGs and for any jackpots in which the given player has participated.

### BRIEF DESCRIPTION OF THE DRAWINGS

The features, aspects, advantages, functions, modules, and components of the devices, systems, and processes provided by the various implementations of the present disclosure are further disclosed herein regarding at least one of the following descriptions and accompanying drawing figures. In the appended figures, similar components or elements of the same type may have the same reference number and may include an additional alphabetic designator, such as 108a-108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When the first reference label is used in the specification, the description is applicable to any of the similar components and/or views having the same first reference label irrespective of any additional alphabetic designators or second reference labels, if any.

FIG. 1 is a schematic illustration of an MJGS and in accordance with at least one implementation of the present disclosure.

FIG. 2 is a schematic of a PIS as utilized in the MJGS of FIG. 1 and in accordance with at least one implementation of the present disclosure.

FIG. 3 is a schematic of a CGAS as utilized in utilized in the MJGS of FIG. 1 and in accordance with at least one implementation of the present disclosure.

FIG. 4 is a schematic of a UMS as utilized in utilized in the MJGS of FIG. 1 and in accordance with at least one implementation of the present disclosure.

FIG. 5 is a schematic of a JMS as utilized in utilized in the MJGS of FIG. 1 and in accordance with at least one implementation of the present disclosure.

FIG. 6 is a schematic of an OCGJTS as utilized in utilized in the MJGS of FIG. 1 and in accordance with at least one implementation of the present disclosure.

FIG. 7 is a schematic of an AMS as utilized in utilized in the MJGS of FIG. 1 and in accordance with at least one implementation of the present disclosure.

FIG. 8 is a process diagram illustrating various operations performed by the components of the MJGS of FIG. 1 and in accordance with at least one implementation of the present disclosure.

FIG. 9 is a process diagram illustrating various operations performed by the components of the MJGS of FIG. 1 to initialize an MJG session and in accordance with at least one implementation of the present disclosure.

FIG. 10 is a process diagram illustrating various operations performed by the components of the MJGS of FIG. 1 to process bets arising for and results from MJG session that includes an OCG and two or more jackpots and in accordance with at least one implementation of the present disclosure.

### DETAILED DESCRIPTION

Various implementations of the present disclosure describe devices, systems and processes for providing multi-jackpot game (MJG) in an OCGS.

As used herein:

“Additional I/O interface” (AIOI) herein refers to one or more components, provided with or coupled to a device, configured to support a receiving and/or presenting of additional inputs and outputs to and from one or more users. An AIOI may be configured to support the receiving and presenting of the additional I/O content (AIO) to users. Herein, the AIO, as communicated, may be referred to as “AIO signals.” An AIO signal may include an audible signal or a visible signal and may be communicated separately or collectively therewith. An AIOI may include any interface not otherwise categorized as an Audio I/O interface or a Visual I/O interface with non-limiting examples including touch pads, keyboards, sensors, motion detectors, tactile elements, and the like. Any known or later arising technologies configured to convey information to or from one or more users as an AIO signal may be utilized for at least one implementation of the present disclosure. An AIOI includes hardware and computer instructions (herein, “AIO technologies”) which supports the input and output of other signals with a user.

“Application” herein refers to a set of computer instructions that configure one or more processors to perform one or more tasks that are other than tasks commonly associated with the operation of the processor itself (e.g., a “system software,” an example being an operating system software), or the providing of one or more utilities provided by a device (e.g., a “utility software,” an example being a print utility). An application may be bundled with a given device or published separately.

“Audio I/O interface” herein refers to one or more components, provided with or coupled to an electronic device, configured to support a receiving and/or presenting of humanly perceptible audible content to one or more users. Such audible content (which is also referred to herein as being “audible signals”) may include spoken text, sounds, or any other audible information. Such audible signals may include one or more humanly perceptible audio signals, where humanly perceptible audio signals typically arise between 20 Hz and 20 KHz. The range of humanly perceptible audio signals may be configurable to support an audible range of a given individual user. An audio I/O interface includes hardware and computer instructions (herein, “audio technologies”) which supports the input and output of audible signals to a user. Such audio technologies may include, but are not limited to, noise cancelling, noise reduction, technologies for converting human speech to text, text to speech, translation from a first language to one or more second languages, playback rate adjustment, playback frequency adjustment, volume adjustments and otherwise. An audio I/O interface may use one or more microphones and speakers to capture and present audible signals respectively from and to a user. Such one or more microphones and speakers may be provided by a given device itself or by a device communicatively couple additional audible device component. For example, earbuds may be communicatively coupled to a smartphone, with the earbuds functioning as an audio I/O interface and capturing and presenting audio signals as sound waves to and from a user, while the smartphone functions as a UD. An audio I/O interface may be configured to automatically recognize, and capture comments spoken by a user and intended as audible signals for sharing with other users, inputting commands, or otherwise.
“Bus” herein refers to any known and/or later arising technologies which facilitate the transfer of data within and/or between devices. Non-limiting examples include Universal Serial Bus (USB), PCI-Express, Compute Express Link (CXL), IEEE-488 bus, High Performance Parallel Interface (HIPPI), and the like.
“Cloud” herein refers to cloud computing, cloud storage, cloud communications, and/or other technology resources which a given user does not actively manage or provide. A usage of a Cloud resource may be private (limited to various users and/or uses), public (available for multiple users and/or uses), hybrid, dedicated, non-dedicated, or otherwise. It is to be appreciated that implementations of the present disclosure may use Cloud resources to provide for processing, storage and other functions related to facilitating pricing of betting lines which account for changes in probabilities occurring due to fixture variations during an event. An implementation may utilize Cloud resources using any known or later arising data delivery, processing, storage, virtualization, or otherwise technologies, standards, protocols, or the like. Non-limiting examples of such technologies include Software as a Service (SaaS), Platform as a Service (Paas), Infrastructure as a Service (Iaas), and the like. Cloud resources may be provided by one or more entities, such as AMAZON WEB SERVICES provided by Amazon.com Inc., AZURE provided by Microsoft Corp., and others.
“Component” herein refers to a Module of a Device, as further defined herein.
“Computer Data” herein refers to a form Data, as further defined herein, configured for use by one or more processors in a device such as a computer and/or a server.
“Computer engine” (or “engine”) herein refers to a combination of a processor and non-transitory computer instruction(s). A computer engine executes computer instructions to perform one or more logical operations (herein, a “logic”) which facilitate various actual (non-logical) and tangible features and function provided by a system, a device, and/or combinations thereof.
“Computer instruction” herein refers to an Instruction, as further defined herein.
“Communications Interface” herein refers to one or more separately provided components and/or integrated with other components of a Device that is configured to facilitate communication of data with one or more other devices using a Coupling. Non-limiting examples of communications interfaces including networking cards, Wi-Fi™ modules, Ethernet ports, Bluetooth radio modules, wireless radio modules, and the like. Any known or later arising components, technologies, protocols, communications mediums, or the like may be used as a communications interface in a given device in an ETS.
“Content” herein refers to data that that may be presented, using a suitable presentation device, to a user in a humanly perceptible format. When presented to a human, the data becomes “information.” Non-limiting examples of content include gaming images and graphics such as those related to bet placement, or otherwise. Content may include, for example and not by limitation, one or more sounds, images, video, graphics, gestures, or otherwise. The content may originate from any source, including live and/or recorded, augmented reality, virtual reality, computer generated, or otherwise. The content may be presented to a given user using any user device and any user interface. Content may be stored, processed, communicated, or otherwise utilized.
“Coupling” herein refers to the establishment of a communications link between two or more elements of a given system. A coupling may utilize any known and/or later arising communications and/or networking technologies, standards, protocols or otherwise. Non-limiting examples of such technologies include packet switch and circuit switched communications technologies, with non-limiting examples including, Wide Area Networks (WAN), such as the Internet, Local Area Networks (LAN), Public Switched Telephone Networks (PSTN), Plain Old Telephone Service (POTS), cellular communications networks such as a 3G/4G/5G or other cellular network, IoT networks, Cloud based networks, private networks, public networks, or otherwise. One or more communications and networking standards and/or protocols may be used, with non-limiting examples including, the TCP/IP suite of protocols, ATM (Asynchronous Transfer Mode), the Extensible Message and Presence Protocol (XMPP), Voice Over IP (VOIP), Ethernet, Wi-Fi, CDMA, Z-WAVE, Near Field Communications (NFC), GSM/GRPS, TDMA/EDGE, EV/DO, WiMAX, SDR, LTE, MPEG, BLUETOOTH, and others. A coupling may include use of physical data processing and communication components. A coupling may be physically and/or virtually instantiated. Non-limiting examples of physical network components include data processing and communications components including computer servers, blade servers, switches, routers, encryption components, decryption components, and other data security components, data storage and warehousing components, and otherwise. Any known or later arising physical and/or virtual data processing and/or communications components may be utilized for a given coupling. A coupling may be “direct”, which herein means that a communication path between two system components does not utilize another, intermediary system component, and/or “indirect” meaning that a communications path between two or more system components may utilize one or more intermediary system components for such communications.
“Data” (which is also referred to herein as a “computer data”) herein refers to any representation of facts, information or concepts in a form suitable for processing, storage, communication, or the like by one or more electronic device processors, data stores, routers, gateways, or other data processing and/or communications devices and systems. Data, while and/or upon being processed, may cause or result in an electronic device or other device to perform at least one function, task, operation, provide a result, or otherwise. Data may be communicated, processed, stored and/or otherwise exist in a transient and/or non-transient form, transitory and/or non-transitory form, as determined by any given state of such data, at any given time. For a non-limiting example, a given data packet may be non-transitory while stored in a storage device, but transient during communication of the given data packet from a first device or system to a second (or more) device or system. When received and stored in memory, data storage device, or otherwise, the given data packet has a non-transitory state. For example, and not by limitation, data may take any form including as one or more applications, content, or otherwise. Instructions, as further described herein, are a form of data.
“Data store” herein refers to any device or combinations of devices configured to store data on a temporary, permanent, non-transitory, or other basis. A data store is also referred to herein as a “computer readable medium.” A data store may store data in any form, such as electrically, magnetically, physically, optically, or otherwise. A data store may include a memory devices, with non-limiting examples including random access memory (RAM) and read only memory (ROM) devices. A data store may include one more storage devices, with non-limiting examples including electrical storage drives such as EEPROMs, Flash drives, Compact Flash (CF), Secure Digital (SD) cards, Universal Serial Bus (USB) cards, and solid-state drives, optical storage drives such as DVDs and CDs, magnetic storage drives such as hard drive discs, magnetic drives, magnetic tapes, memory cards, and others. Any known or later arising memory and data storage device technologies may be utilized for a given data store. Available storage provided by a given one or more data stores may be partitioned or otherwise designated by the storage controller as providing for permanent storage and temporary storage. Non-transitory data, non-transitory computer instructions, or other the like may be suitably stored in a data store. As used herein, permanent storage is distinguished from temporary storage, with the latter providing a location for temporarily storing data, variables, or other instructions used for a then arising or soon to arise data processing operations. A non-limiting example of a temporary storage is a memory component provided with and/or embedded onto a processor or integrated circuit provided therewith for use in performing then arising data calculations and operations. Accordingly, it is to be appreciated that a reference herein to “temporary storage” is not to be interpreted as being a reference to transient or transitory storage of data. Permanent storage and/or temporary storage may be used to store transitory and non-transitory data with the data, while stored, being herein deemed to be non-transitory data.
“Device” and “electronic device” herein refer to any known or later arising electrical device configured to, singularly and/or in combination, communicate, manipulate, output for presentation as information to a human, process, store, or otherwise utilize data. Non-limiting examples of devices include user devices and servers.
“Instruction” (which is also referred to herein as a “computer instruction”) herein refers to a non-transitory processor executable instruction, associated data structures, sequence of operations, program modules, or the like. An instruction is described by an instruction set. It is commonly appreciated that instruction sets are often processor specific and accordingly an instruction may be executed by a processor in an assembly language or machine language format that is translated from a higher level programming language. An instruction may be provided using any form of known or later arising programming; non-limiting examples including declarative programming, imperative programming, functional programming, procedural programming, stack based programming, object-oriented programming, and otherwise. An instruction may be performed by using data and/or content stored in a data store on a transient, non-transient, transitory and/or non-transitory basis, as may arise for any given data, content and/or instruction. While the data for one or more instructions is being utilized, such use is herein deemed to occur on a non-transient and non-transitory basis.
“Module” herein refers to and, when claimed, recites definite structure for a device that is configured to provide at least one feature and/or output signal and/or perform at least one function including one or more of the features, output signals and functions described herein. A module may provide the one or more functions using computer engines, processors, computer instructions, applications, modules, and the like. When a feature, output signal and/or function is provided, in whole or in part, using a processor, one more software components may be used, and a given module may include a processor configured to execute computer instructions. A person having ordinary skill in the art (a “PHOSITA”) will appreciate that the specific hardware and/or computer instructions used for a given implementation will depend upon the functions to be accomplished by a given module. Likewise, a PHOSITA will appreciate that such computer instructions may be provided in firmware, as embedded software, provided in a remote and/or local data store, accessed from other hosts on an as-needed basis, or otherwise. Any known or later arising technologies may be used to provide a given module and the features and functions supported therein.
“Player Device” herein refers to a device configured for use by a human being to one or more of communicate, present, process, and store data. Non-limiting examples of player devices include smartphones, laptop computers, tablet computing devices, desktop computers, smart televisions, smart glasses, virtual reality glasses, augmented reality glasses, earbuds/headphones and other audible output devices, and other devices.
“Power Supply/Power” herein refers to any known or later arising technologies which facilitate the use of electrical energy by a device. Non-limiting examples of such technologies include batteries, power converters, inductive charging components, line-power components, solar power components, and otherwise.
“Processor” herein refers to one or more known or later developed hardware processors and/or processor systems configured to execute one or more computer instructions, with respect to one or more instances of computer data, and perform one or more logical operations. The computer instructions may include instructions for executing one or more applications, software engines, and/or processes configured to perform computer executable operations. Such hardware and computer instructions may arise in any computing configuration including, but not limited to, local, remote, distributed, blade, virtual, Cloud based, or other configurations and/or system configurations. Non-limiting examples of processors include discrete analog and/or digital components that are integrated on a printed circuit board, as a system on a chip (SOC), or otherwise; Application specific integrated circuits (ASICs); field programmable gate array (FPGA) devices; digital signal processors; general purpose processors such as 32-bit and 64-bit central processing units; multi-core ARM based processors; microprocessors, microcontrollers; and the like. Processors may be implemented in single or parallel or other implementation structures, including distributed, Cloud based, multi-threaded and otherwise.
“Security Component/Security Module/Security” herein refers to any known or later arising processor, computer instruction, and/or combination thereof configured to secure data as communicated, processed, stored, or otherwise manipulated. Non-limiting examples of security components include those implement encryption standards, such as an Advanced Encryption Standard (AES), and transport security standards, such as Transport Layer Security (TLS) or Secure Sockets Layer (SSL).
“Server” herein refers to one or more devices that include computer hardware and/or computer instructions that provide functionality to one or more other programs or devices (collectively, “clients”). Non-limiting examples of servers include database servers, file servers, application servers, web servers, communications servers, virtual servers, computing servers, and the like. Servers may be combined into clusters (e.g., a server farm), logically or geographically grouped, or otherwise. Any known or later arising technologies may be used for a server. A server may instantiate one or more computer engines as one or more threads operating on a computing system having a multiple threaded operating system, such as the WINDOWS, LINUX, APPLE OS, ANDROID, and other operating systems, as an application program on a given device, as a web service, as a combination of the foregoing, or otherwise. An Application Program Interface (API) may be used to support an implementation of the present disclosure. A server may be provided in the virtual domain and/or in the physical domain. A server may be associated with a human user, a machine process executing on one or more computing devices, an API, a web service, instantiated on the Cloud, distributed across multiple computing devices, or otherwise. A server may be any electronic device configurable to communicate data, using a network or otherwise, directly or indirectly, to another device, to another server, or otherwise.
“Service” herein refers to and, when claimed, recites definite structure for one or more singular or when combined (logically, physically, virtually, or otherwise) electrical/electronic device(s) that are configured to provide at least one feature and/or output signal and/or perform at least one function including the features, output signals and functions described herein. A service may provide the one or more functions using computer engines, processors, computer instructions and the like. A service may be Cloud or otherwise based. When a feature, output signal and/or function is provided, in whole or in part, using a processor, one more software components may be used, and a given service may include a processor configured to execute computer instructions. A person having ordinary skill in the art (a “PHOSITA”) will appreciate that the specific hardware and/or computer instructions used for a given implementation will depend upon the functions to be accomplished by a given service. Likewise, a PHOSITA will appreciate that such computer instructions may be provided in firmware, as embedded software, provided in a remote and/or local data store, accessed from other sources on an as-needed basis, or otherwise. Any known or later arising technologies may be used to provide a given module and the features and functions supported therein.
“Substantially simultaneous(ly)” herein refers to an absence of a greater than expected and humanly perceptible delay between a first event or condition, such as a completion of an activity, and a second event or condition, such as a placing of a bet for a given activity where one or more betting lines have been modified in view of a currently occurring fixture. Substantial simultaneity may vary in a range of quickest to slowest expected delay, to a moderate delay, or to a longer delay. For at least one implementation, substantial simultaneity occurs within an acceptable delay (as described above).
“User” and “Player” herein refers to a single person and/or a group of users who are being presented, via a suitable user device, with a given content, at a given time.
“User Device (UD)” herein refers to a device configured for use by a user to communicate, generate, compute, present, process, store, or otherwise manipulate data and/or information. Non-limiting examples of user devices include smartphones, laptop computers, tablet computing devices, desktop computers, smart televisions, smart glasses, virtual reality glasses, expanded reality glasses, earbuds/headphones and other audible output devices, and other devices.
“User Interface” herein refers to one more components, provided with or coupled to a device configured to receive information from and/or present information to a user, a player or the like. A user interface may include one more Additional I/O interfaces, Audio I/O interfaces, and Visual I/O interfaces.
“Visual I/O interface” herein refers to one or more components, provided with or coupled to a device, configured to support a receiving and/or presenting of humanly perceptible visual content to one or more users. A visual I/O interface may be configured to support the receiving and presenting of visual content (which is also referred to herein as being “visible signals”) to users. Such visible signals may be in any form, such as still images, motion images, augmented reality images, virtual reality images, and otherwise. A visual I/O interface includes hardware and computer instructions (herein, “visible technologies”) which supports the input by and output of visible signals to users via a device. Such visible technologies may include technologies for converting images (in any spectrum range) into humanly perceptible images, converting content of visible images into a given user's perceptible content, such as by character recognition, translation, playback rate adjustment, playback frequency adjustment, and otherwise. A visual I/O interface may be configured to use one or more display devices, such as an internal display and/or external display for a given device with the display(s) being configured to present visible signals to a user. A visual I/O interface may be configured to use one or more image capture devices to capture content. Non-limiting examples of image capture devices include lenses, cameras, digital image capture and processing software, and the like. Accordingly, it is to be appreciated that any existing or future arising visual I/O interfaces, devices, systems and/or components may be utilized by and/or in conjunction with a device to facilitate the capture, communication and/or presentation of visible signals to a user.

### Multi-Jackpot Game System (MJGS) 100

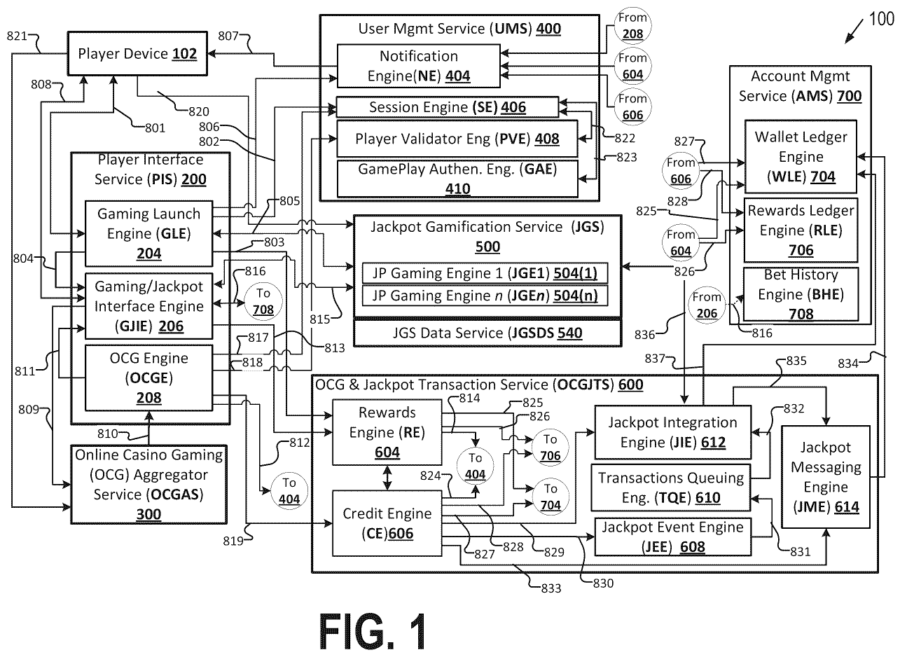

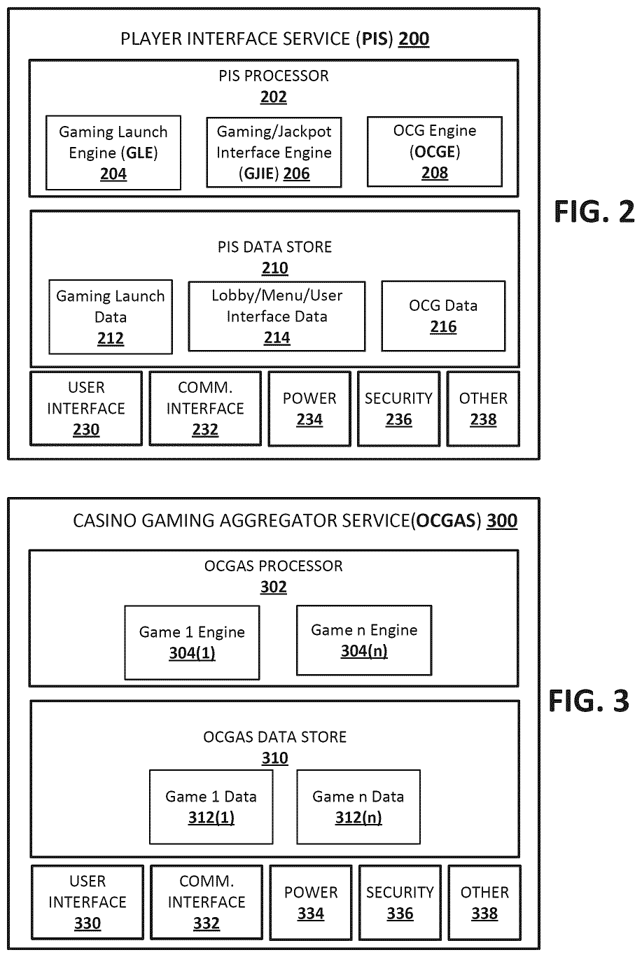

As shown in FIG. 1 and for at least one implementation of the present disclosure, an MJGS 100, may include: at least one player device 102; at least one player interface service (PIS) 200; a least one online casino gaming aggregator service (OCGAS) 300; at least one user management service (UMS) 400; at least one jackpot gamification service (JGS) 500; at least one OCG and jackpot transaction service (OCGJTS) 600; and at least one account management service (AMS) 700. For at least one implementation “n” instances (where, “n” is an integer) of the player device 102, PIS 200, CGAS 300, UMS 400, JGS 500, OCGJTS 600 and/or AMS 700 may be utilized in a given implementation of the present disclosure. Other known and/or later arising services which facilitate multi-jackpot games may also and/or alternatively be used in other implementations of the present disclosure. As shown in FIGS. 2-7, each of the PIS 200, CGAS 300, UMS 400, JGS 500, GJTS 600, and AMS 700 may include and/or have access to: at least one user interface, as defined herein, including user interfaces 230, 330, 430, 530, 630, and 730; at least one communications interface, as defined herein, including communications interfaces 232, 332, 432, 532, 632, and 732; at least one power, as defined herein, including power 234, 334, 434, 535, 634 and 734; at least one security, as defined herein, including security 236, 336, 436, 536, 636 and 736; and at least one “other” module, include other modules 238, 338, 438, 538, 638 and 738. As shown, the various elements of the MJGS may be suitably coupled by a first coupling 801 through a thirty-seventh coupling 837. Additional, lesser and/or alternative couplings may be utilized in other implementations of the present disclosure.

### Player Interface Service (PIS) 200

As shown in FIG. 2 and in accordance with at least one implementation, the PIS 200 may include a PIS processor 202 configured to execute, respectively, first, second and third PIS computer instructions which instantiate one or more of a gaming launch engine (GLE) 204, a gaming/jackpot interface engine (GJIE) 206, and an OCG engine (OCGE) 208. The GLE 204, pursuant to the first PIS computer instructions (1PISCI), configures the PIS 200 to perform gaming launch operations (GLOs). The GJIE 206, pursuant to the second PIS computer instructions (2PISCI), configure the PIS 200 to perform gaming and jackpot interface operations (GJIO). The OCGE 208, pursuant to the third PIS computer instructions (3PISCI), configures the PIS 200 to perform one or more OCG operations (OCGO). The PIS 200 may be configured to fetch an update data regarding an OCG and MJGs available to and/or being “played” by a player at a given time.

It is to be appreciated that the reference to first, second, third or the like is used herein for purposes explanation of implementations of the present disclosure and are not to be construed to require a particular sequence of events, operations, or the like.

The 1PISCI, 2PISCI and 3PISCI may be non-transitorily stored in a PIS data store 210 coupled to the PIS processor 202 by a bus (not shown) or other direct or indirect coupling. The GLE 204 may utilize data stored in the PIS data store 210 as gaming launch data. The GJIE 206 may utilize data stored in the PIS data store 210 as one or more of lobby, menu, and/or user interface data 214. The OCGE 208 may utilize data stored in the PIS data store 210 as OCG data 216.

Gaming Launch Engine (GLE) 204: For at least one implementation, the GLE 204 may be configured to launch a player into an OCG. The GLE 204, GJIE 206 and OCGE 208 may be configured to fetch and update (as appropriate) player and OCG specific data. Such data may be presented to a player, via a player device user interface to inform the player of an OCG mode, OCG credit balance, player and OCG permissions, jackpot configurations and availabilities, and a gameplay mode requested by the player (for example, a MJG gameplay mode). To fetch and update such data, one or more of the GLE 204, GJIE 206 and OCGE 208 may request data, directly or indirectly, from one or more of the OCGAS 300, the UMS 400, the JGS 500, the OCGJTS 600, and the AMS 700. Data retrieved pursuant to one or more of such operations may be non-transitorily stored in the PIS data store 210 and/or elsewhere in the MJGS 100.

Gaming/Jackpot Interface Engine (GJIE) 206: For at least one implementation, the GJIE 206 may be configured to manage configurations of games, jackpots, and lobbies, as ultimately presented on a graphical user interface (GUI) provided by a PD 102. The GJIE 206 may be configured to retrieve data regarding OCGs from the OCGAS 300 and/or other MJGS 100 components based on gaming category. Additional data useful in configuring the GUI on the PD 102 may be processed by the GJIE 206. For at least one implementation, the data obtained by the GJIE 206 from the MJGS 100 components may include data providing strategy for launch of a jackpot game, jackpot round outcome retrieval results, and other data regarding each of two or more jackpots available to PD 102. For at least one implementation, such data may further include data regarding one or more jackpots that are unavailable to the PD 102, jackpots currently active, past jackpots played, and the like.

Online Casino Game Engine (OCGE) 208: For at least one implementation, the OCGE 208 may be configured as an interface for gameplay requests to and from the OCGAS 300. It is to be appreciated that each OCGAS 300, of which there may be many for a given MJGS 100, may utilize a unique command, data, and other structure. Accordingly, the OCGE 208 may be configured to include multiple interfaces with at least one interface being provided for each OCGAS 300 utilized in conjunction with a given implementation of an MJGS 100. The OCGE 208 may be further configured to include one or more instance of OCGAS 300 interface logic which enables the MJGS 100 to process and send requests from and to the OCGEs 200 utilized. The OCGE 208 may be configured to forward the as processed request to and from the OCGASs 300 used in a given implementation to other MJGS 100 components, such as the GJIE 206 and others.

### Online Casino Gaming Aggregator Service (OCGAS) 300

As shown in FIG. 3 and in accordance with at least one implementation, the OCGAS 300 may include an OCGAS processor 302 configured to execute, respectively, first through nth OCGAS computer instructions (nOCGCI) which instantiate one or more of a first game engine (GE1) 304(1) through an nth game engine (GEn) 304(n). A gaming engine 304 is configured to perform one or more gaming aggregator operations (GAO) that may include, without limitation, processing a player's virtual game play actions, example, a pulling of a slot machine lever, a selection of a roulette number, a throwing of craps dice, or the like and applying established game logic and rules, determine a result of the game play action (e.g., a win, draw, pass, loss, or the like). It is to be appreciated that a game play action in which a player may virtually partake is OCG dependent and may vary from one OCG to another.

The nOCGCI may be non-transitorily stored in an OCGAS data store 310 coupled to the OCGAS processor 302 by a bus (not shown) or other direct or indirect coupling. A GEn 304(n) may utilize data stored in the OCGAS data store 310 to provide OCG data to a PD 102 or another component of the MJGS 100. The OCGE 208 may store data in the OCGAS data store 310 as Game (1-n) data 312(1-n).

### User Management Service (UMS) 400

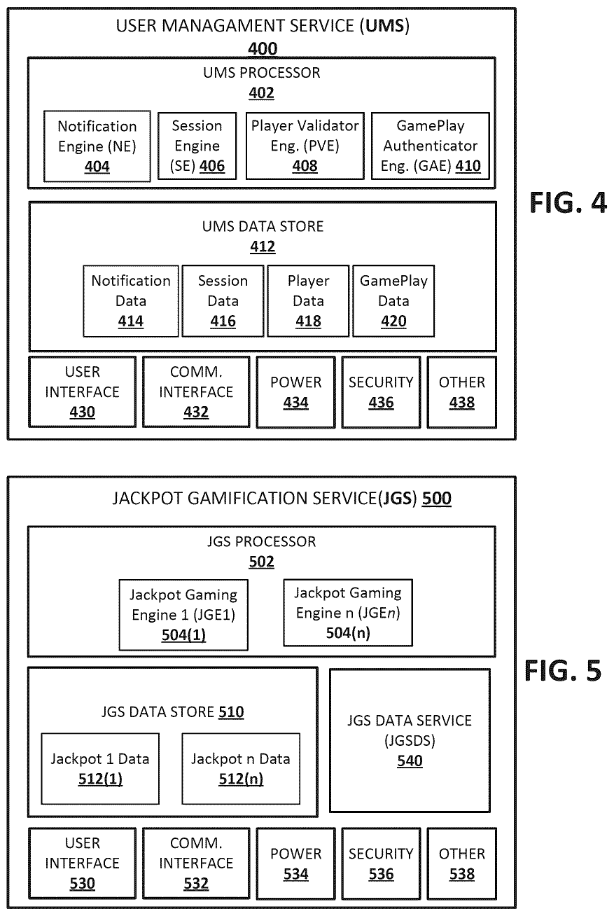

As shown in FIG. 4 and in accordance with at least one implementation, the UMS 400 may include a UMS processor 402 configured to execute, respectively, 1st through 4th UMS computer instructions (nUMSCI) which respectively instantiate a notification engine (NE) 404, a session engine (SE) 406, a player validator engine (PVE) 408, and a gameplay authenticator engine (GAE) 410.

The nUMSCI and data used by the UMS engines may be non-transitorily stored in a UMS data store 410 coupled to the UMS processor 402 by a bus (not shown) or other direct or indirect coupling. A UMSCI may utilize data stored in the UMS data store 410 to provide data and/or computer instructions for use by one or more of the NE 404, SE 404, PVE 408, GAE 410, and/or another component of the MJGS 100. The UMS 400 may store data in the UMS data store 410 as one or more of notification data 414, session data 416, player data 418, gameplay data 420, and/or other data.

Notification Engine (NE) 404: For at least one implementation, the NE 404 may be configured implement 1UMSCIs that configure the UMS 400 to perform one or more notification engine operations (NEO). For at least one implementation, the NEOs may include communicating notifications to the PD 102. The notifications may include data provided by one or more other MJGS 100 components. The NE 404 may non-transitorily store notifications in the UMS data store 412 as notification data 414. Such notifications may be communicated in any order sequence, synchronously, asynchronously, or otherwise. For at least one implementation, operations performed by the MJGS may be performed asynchronously and notifications communicated, by the NE 404 to the PD 102 asynchronously.

Session Engine (SE) 406: For at least one implementation, the SE 406 may be configured to implement 2UMSCIs that configure the UMS 400 to perform one or more session engine operations (SEOs). For at least one implementation, the SEOs may include managing each gaming session. The SEOs may include receiving data from other MJGS components regarding the player, games and jackpots being played, and the like. The SEOs may include providing an interface by which a gaming session may be created, validated, extended, terminated, or the like. Data generated by and/or utilized by the SE 406 may be non-transitorily stored in the UMS data store 412 as session data 416.

Player Validator Engine (PVE) 408: For at least one implementation, the PVE 408 may be configured to implement 3UMSCIs that configure the UMS 400 to perform one or more player validator engine operations (PVEO). For at least one implementation, the PVEOs may include managing player data including receiving, storing, validating, monitoring and/otherwise managing players for participation in a given session, OCG and/or one or more jackpots. Such data may be non-transitorily stored in the UMS data store 412 as player data 418. The operations of the PVE 408 are beyond the scope of the present disclosure and any known or later arising devices, systems, process, or the like for validating and/or managing players with respect to one or more OCGs and/or one or more jackpots may be utilized in an implementation of the present disclosure.

Gameplay Authenticator Engine (GAE) 410: For at least one implementation, the GAE 410 may be configured to implement 4UMSCIs that configure the UMS 400 to perform one or more gameplay authenticator engine operations (GAEO). For at least one implementation, the GAEOs may include monitoring and authenticating OCG and jackpot gameplay actions The GAE 410 may utilize various data regarding rules, permissions, actions permissible, actions impermissible, and the like (herein “gaming rules”) regarding each of the OCGs and jackpots provide by the MJGS 100. It is to be appreciated that gaming rules may vary by OCG, jackpot, player, jurisdiction, and otherwise. Accordingly, and for at least one implementation, the GAE 410 may non-transitorily store such gaming rules and other data relating to a generic OCG and/or jackpot as well as player specific data relating thereto in the UMS data store 412 as gameplay data 420.

### Jackpot Gamification Service (JGS) 500

As shown in FIG. 5 and in accordance with at least one implementation, the JGS 500 may include a JGS processor 502 configured to execute, respectively, 1st through nth JGS computer instructions (nJGSCI) which respectively instantiate each instance of one (1) to n jackpot gaming engines (JGEn) 504, shown as JGE1 504(1) through JGEn 504(n). A given JGE may be configured to perform one or more jackpot operations (JO). The JOs performed may vary by jackpot and may commonly include acceptance of a jackpot and a corresponding wager amount to be debited against a given player's account upon performance of a gameplay turn in an OCG associated with the given jackpot. For example, an OCG (such as a slot machine game) may include a minimum wager of one dollar ($1.00). A first jackpot associated with the OCG may include a wager of ten cents ($0.10) and a second jackpot associated with the OCG may include a wager of twenty cents ($0.20). Accordingly, with a given player elects to both take a spin of the slot machine wheel (by pulling a virtual slot machine arm) and participate in both the first jackpot and the second jackpot, a wager amount of $1.30 will be debited against the players account.

The nJGSCI and data used by the JGEs may be non-transitorily stored in a JGS data store 510 coupled to the JGS processor 502 by a bus (not shown) or other direct or indirect coupling. A JGSCI may utilize data stored in the JGS data store 510 to provide data and/or computer instructions for use by one or more of the JGEn and/or another component of the MJGS 100. The JGS processor 402 may store data in the JGS data store 510 as one or more of jackpot 1 data 512(1) through jackpot n data 512(n), and/or other data. The data used by a given JGEn to facilitate a jackpot may include utilize “jackpot rules” regarding the presentation, playing, reporting of results, and the like for each of two or more given jackpots. It is to be appreciated that such jackpot rules may vary by jackpot, underlying OCG being played, jurisdiction, and otherwise.

For at least one implementation, the JGS may include and/or be coupled to a JGS data service (JGSDS) 540. The JGSDS provides, upon request, and/or publishes to subscribing components of the MJGS 100 (which may include the PD 102, the PIS 200 and other components) a listing of jackpots currently active, amounts of the currently active, jackpots, and updates thereto the currently active jackpots. The PD 102 may be configured to subscribe to receive updates from the JGSDS 540. The JGSDS 540 may receive such updates from each of the jackpot gaming engines 504 active at a given current time. The JGSDS 540 may be configured to associate currently active jackpots, and publish updates thereto, to those PD 102 that are currently actively participating in an OCG associated with a given one or more currently active jackpots. Accordingly, the MJGS 100 may be configured such that the providing of updates to currently active jackpots to the PDs 102 currently participating therein can be separated from the providing of the jackpot game statuses, as provided by each of the jackpot gaming engines 504, then currently active.

For at least one implementation, the JGSDS 540 may be scaled up/down to include multiple instances thereof which can support the timely providing of jackpot updates to the often numerous (thousands or more) of PDs 102 that may be currently actively participating in each of two or more jackpots.

For at least one implementation, the JGSDS 540 may be provided as a service of the JGS 500 and/or as a separate service. When provided as a separate service, one or more additional direct and/or indirect couplings between the PD 102 and the JGSDS 540, the PIS 200 and the JGSDS 540, and otherwise, may be utilized.

### OCG and Jackpot Transaction Service (OCGJTS) 600

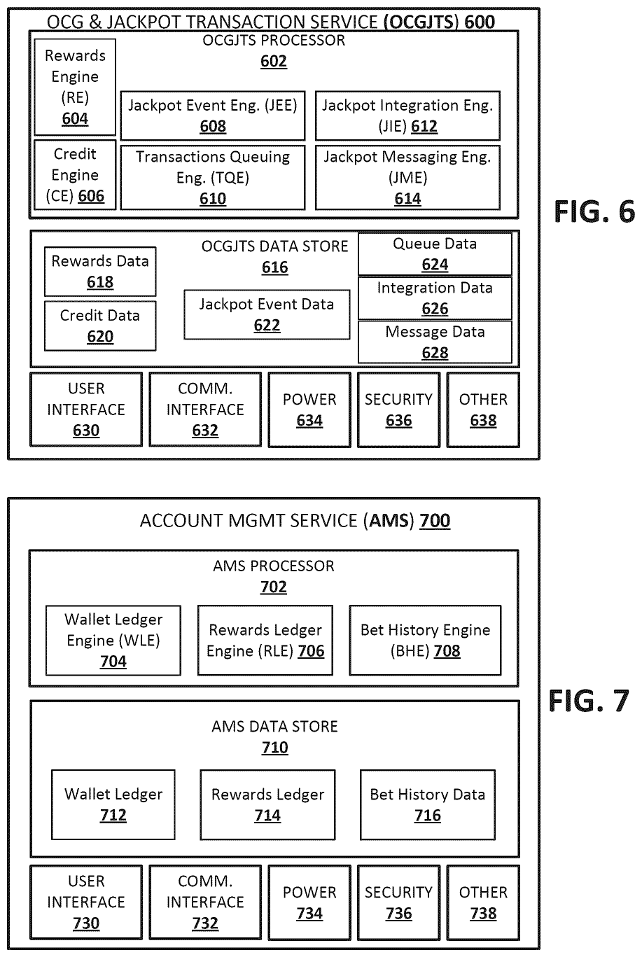

As shown in FIG. 6 and in accordance with at least one implementation, the OCGJTS 600 may include an OCGJTS processor 602 configured to execute, respectively, 1st through 6^{th} OCGJTS computer instructions (OCGJTSCI) which respectively instantiate a rewards engine (RE) 604, a cash engine (CE) 606, a jackpot event engine (JEE) 608, a transactions queueing engine (TQE) 610, a jackpot integration engine (JIE) 612, and a jackpot messaging engine (JME) 614.

The OCGJTSCIs and data used by the RE 604, CE 606, JEE 608, TQE 610, JIE 612 and/or JME 614 may be non-transitorily stored in a OCGJTS data store 610 coupled to the OCGJTS processor 602 by a bus (not shown) or other direct or indirect coupling. An OCGJTSCI may utilize data stored in the OCGJTS data store 610 to provide data and/or computer instructions for use by one or more of the foregoing engines and/or other component of the MJGS 100 to process financial transactions related to the playing of an OCG and multiple jackpot games associated with the OCG gameplay. The OCGJTS processor 602 may store data in the OCGJTS data store 610 as one or more of rewards data 618, credit data 620, jackpot event data 622, queue data 624, integration data 626, message data 628, and/or other data. The data used by a given OCGJTS engine to facilitate transactional aspects of game play may vary by the OCG and/or jackpots being played at a given time and by a given player.

Rewards Engine (RE) 604: For at least one implementation, the RE 604 may be configured to implement 1OCGJTSCIs that configure the OCGJTS 600 to perform one or more rewards engine operations (REO) including processing rewards arising from gameplay, or otherwise provided by an MJGS operator to a given player. For at least one implementation, rewards may be utilized in conjunction with a given, one or more OCGs but may not be used to satisfy any wager amounts required from a player to participate in a jackpot. For another implementation, rewards may be used for participation in OCGs and/or jackpots. The RE 604 may be configured to communicate with the AMS 700 when rewards are redeemed by a given participant. The RE 604 may utilize and/or store rewards data 618 in the OCGJTS data store 616 and/or in other MJGS 100 components.

Credit Engine (CE) 606: For at least one implementation, the SE 606 may configure to implement 2OCGJTSCIs that configure the OCGJTS 600 to perform one or credit engine operations (CEO) including processing credit transactions (as opposed to reward transactions) arising from gameplay by a player in an OCG and/or one or more jackpots. The CE 606 may utilize and/or store credit data 620 in the OCGJTS data store 616 and/or in other MJGS 100 components.

Jackpot Event Engine (JEE) 608: For at least one implementation, the JEE 608 may configure to implement 3OCGJTSCIs that configure the OCGJTS 600 to perform one or jackpot event engine operations (JEEO). The JEE 608 may utilize and/or store jackpot event data 622 in the OCGJTS data store 616 and/or in other MJGS 100 components.

Transactions Queuing Engine (TQE) 610: For at least one implementation, the TQE 610 may configure to implement 4OCGJTSCIs that configure the OCGJTS 600 to perform one or transaction queueing engine operations (TQEO) including receiving and managing, in a queue or other data structure, data from the JEE 608 indicative of one or more jackpot events. For at least one implementation, the MJGS 100 may utilize an asynchronous data processing environment. The TQE 610 facilitates the ordered processing of jackpot event data, even when such data is not received synchronously. The TQE 610 may utilize and/or store queue data 624 in the OCGJTS data store 616 and/or in other MJGS 100 components.

Jackpot Integration Engine (JIE) 612: For at least one implementation, the JIE 612 may configure to implement 5OCGJTSCIs that configure the OCGJTS 600 to perform one or jackpot integration engine operations (JIEO) including integrating a casino platform, on which a given of one or more OCGs may be presented for play by a player at any given time, with a jackpot platform, one which one or more jackpots including multi-jackpot games, may be also presented to the given player at a given time. ne For at least one implementation the JIEOs may include negotiating authentication tokens for use in OCG web based and native (application) based implementations, wherein the authentication tokens may also be utilized to get jackpot games, jackpot events, and jackpot winnings data from the JGS 500 and/or other MJGS 100 components. For at least one implementation, the JIEOs may include communicating OCG winnings to the JGS 500 to determine if a winning OCG gameplay qualifies as a win for one or more jackpots in which a given player has selected to participate in conjunction with the player's participation in the given OCG. For at least one implementation, the JIEOs may include receiving notification form the JGS 500 when a jackpot has been won by a given player and further communicating the winning jackpot event to the AMS 700 for processing thereby and crediting of the given player's account with the amount of the jackpot winnings or the like. The JIE 612 may utilize and/or store integration data 626 in the OCGJTS data store 616 and/or in other MJGS 100 components.

Jackpot Messaging Engine (JME) 614: For at least one implementation, the JME 614 may be configured to implement 5OCGJTSCIs that configure the OCGJTS 600 to perform one or jackpot messaging engine operations (JMEO) including communicating data from one or more of the CE 606, the JIE 612, and/or other MJGS 100 components to the AMS 700 for processing thereby. The JME 614 may utilize and/or store queue data 624 in the OCGJTS data store 616 and/or in other MJGS 100 components.

### Account Management Service (AMS) 700

As shown in FIG. 7 and in accordance with at least one implementation, the AMS 700 may include an AMS processor 702 configured to execute, respectively, 1st through 3^{rd} AMS computer instructions (AMSCI) which respectively instantiate a wallet ledger engine (WLE) 704, a rewards ledger engine (RLE) 706, and a bet history engine (BHE) 708.

The AMSCIs and data used by the WLE 704, RLE 706, and BHE 708 may be non-transitorily stored in an AMS data store 710 coupled to the AMS processor 702 by a bus (not shown) or other direct or indirect coupling. An AMSCI may utilize data stored in the AMS data store 710 to provide data and/or computer instructions for use by one or more of the foregoing engines and/or other component of the MJGS 100 to process financial transactions related to the playing of an OCG and multiple jackpot games associated with the OCG gameplay. The AMS processor 702 may store data in the AMS data store 710 as one or more of a wallet ledger 712, a rewards ledger 714, as bet history data 716, and/or other data. The data used by a given AMS engine to facilitate transactional aspects of game play may vary by the OCG and/or jackpots being played at a given time and by a given player.

Wallet Ledger Engine (WLE) 704: For at least one implementation, the WLE 704 may be configured to implement 1AMSCIs that configure the AMS 700 to perform wallet ledger engine operations (WLEO) including maintaining account records for each player participating in the MJGS 100 at any given time. The account records may include debits and credits to a wallet ledger 712 maintained in the AMS data store 710. A distinct wallet ledger 712 may be maintained for each player.

Rewards Ledger Engine (RLE) 706: For at least one implementation, the RLE 704 may be configured to implement 2AMSCIs that configure the AMS 700 to perform rewards ledger engine operations (RLEO) including maintaining rewards records for each player participating in the MJGS 100 at any given time. The rewards records may include debits and credits to a rewards ledger 714 maintained in the AMS data store 710. A distinct rewards ledger 714 may be maintained for each player.

Bet History Engine (BHE) 708: For at least one implementation, the BHE 708 may be configured to implement 3AMSCIs that configure the AMS 700 to perform bet history engine operations (BHEO) including maintaining records for each bet placed by a given player participating in the MJGS 100 at any given time. The bet history records may include hands played, bets placed, results of game play and any other data relating to a given player's participating in a “hand” (or “spin” or other distinct gameplay event) for an OCG and/or one or more jackpots associated with a given one or more OCGs (collectively, a “player's betting history”). The players betting history may be stored as bet history data 716 in one or more files or other data structures maintained in the AMS data store 710. A distinct bet history data 716 may be maintained for each player.

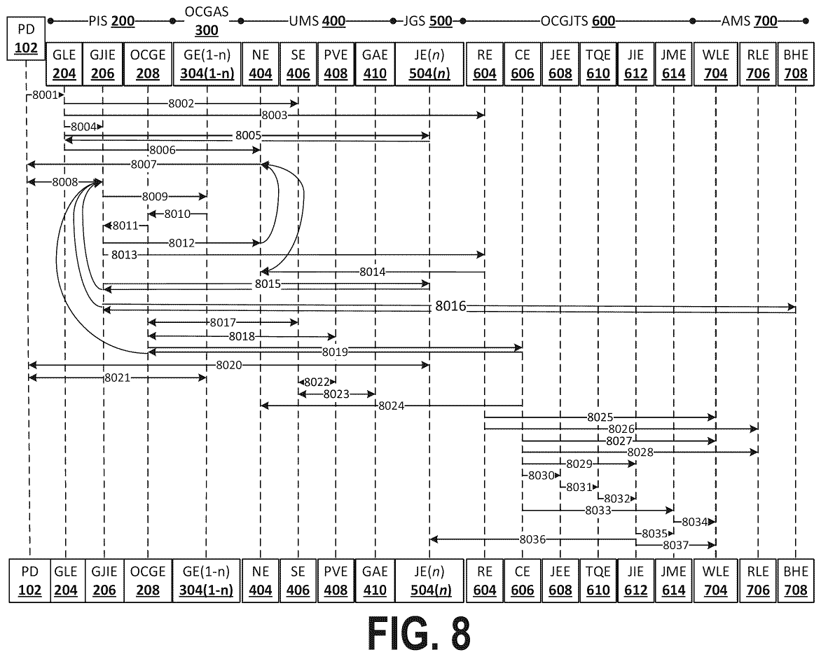

As shown in FIG. 8 and for at least one implementation of the present disclosure, operations performed by the PIS 200, via one or more of the GLE 204, the GJIE 206 and the OCGE 208, may include a first operation (1^{st} Op) 8001 of receiving by the GLE 204 and via a first coupling 801 (as shown in FIG. 1), an identification of a given player from the player device 102. Data received pursuant to the first operation 901 may be non-transitorily stored in the PIS data store 210 and/or elsewhere in the MJGS 100.

As further shown in FIG. 8 for at least one implementation of the present disclosure, a second operation (2^{nd} Op) 8002, may include the GLE 204 querying, via a second coupling 802 (as shown in FIG. 1), a session engine (SE) 406 (as described hereinbelow) instantiated by the UMS 400, for a player session identifier and a play mode for a given player identified by the player device 102 via the first coupling 801. Data retrieved pursuant to the second operation may be non-transitorily stored in the PIS data store 210, the UMS data store 412, and/or elsewhere in the MJGS 100.

As further shown in FIG. 8 for at least one implementation of the present disclosure, a third operation (3^{rd} Op) 8003 may include the GLE 204 querying, via a third coupling 803 (as shown in FIG. 1), a rewards engine (RE) 604 (as described hereinbelow and as instantiated by the OCGJTS 600) for any rewards to which the given player has earned or is otherwise entitled. Data retrieved pursuant to the third operation may be non-transitorily stored in the PIS data store 210, the OCGJTS data store 616 and/or elsewhere in the MJGS 100.

As further shown in FIG. 8 for at least one implementation of the present disclosure, a fourth operation (4^{th} Op) 8004 may include the GLE 204 querying, via a fourth coupling 804 (as shown in FIG. 1), the gaming jackpot interface engine (GJIE) 206 for jackpot data 512 associated with an OCG selected by the player. This operation may be repeated with respect to each of “n” jackpots that may be associated, at any given time, with a given OCG selected by the player. For at least one implementation, the GJIE 206 may be configured to request and receive data regarding up to ten (10) jackpots that may be made available to a given player to wager against and with respect to gameplay arising for given OCG selected by the player. Data retrieved pursuant to the fourth operation 8004 may be non-transitorily stored in the PIS data store 210, the JGS data store 510, and/or elsewhere in the MJGS 100.

As further shown in FIG. 8 for at least one implementation of the present disclosure, a fifth operation (5^{th} Op) 8005 may include the GLE 204 querying, via a fifth coupling 805 (as shown in FIG. 1), each of one or more jackpot engines JE(1-n) as instantiated by the JGS 500, for an identification of one or more (“n”) jackpots available for play by the player in view of the data returned via the 4^{th} operation 8004. Data retrieved pursuant to the fifth operation 8005 may be non-transitorily stored in the PIS data store 210, the JGS data store 510, and/or elsewhere in the MJGS 100.

As further shown in FIG. 8 for at least one implementation of the present disclosure, a sixth operation (6^{th} Op) 8006 may include the GLE 204 communicating, via sixth coupling 806 (as shown in FIG. 1), to a notification engine (NE) 404 instantiated by the UMS 400, one or more of the data obtained via one of or more of the above described 1^{st} through 5th operations 8001-8005. The data so communicated may be retrieved from the PIS data store 210, and/or one or more of the above described data stores and stored by the UMS data store 412, and/or elsewhere in the MJGS 100.

As further shown in FIG. 8 for at least one implementation of the present disclosure, a seventh operation (7^{th} Op) 8007 may include the NE 404 communicating, via a seventh coupling 807 (as shown in FIG. 1), data received from the GLE 204 (via the sixth operation 8006) to the PD 102.

As further shown in FIG. 8 for at least one implementation of the present disclosure, an eighth operation (8^{th} Op) 8008 may include the GJIE 206 receiving a request from and replying to the PD 102, via an eighth coupling 808 (as shown in FIG. 1) with the player device 102, outcomes of OCGs and/or jackpots previously played by the given player. Data retrieved pursuant to one or more of eighth operation 8008 may be non-transitorily stored in the PIS data store 210 and/or elsewhere in the MJGS 100.

As further shown in FIG. 8 for at least one implementation of the present disclosure, a ninth operation (9^{th} Op) 8009 may include the GJIE 206 querying, via a ninth coupling 809 (as shown in FIG. 1), for an identification of one or more instances of “n” gaming engines (GE(1-n)) 304(1-n), as to be identified by the OCGAS 300, that are available for play by the PD 102, and data regarding categories thereof (e.g., slots, table games, and the like), and the specific games therein available for play by the PD 102.

As further shown in FIG. 8 for at least one implementation of the present disclosure, a tenth operation (10^{th} Op) 8010 may include the GE(1-n) 304(1-n), in response to ninth operation 8009, communicating the responsive data to the OCGE 208, via a tenth coupling 810 (as shown in FIG. 1) therebetween.

As further shown in FIG. 8 for at least one implementation of the present disclosure, an eleventh operation (11^{th} Op) 8011 may include the OCGE 208 further communicating the data provided pursuant to 10^{th} operation 8010 to the GJIE 206, via an eleventh coupling 811 (as shown in FIG. 1) therebetween.

As further shown in FIG. 8 for at least one implementation of the present disclosure, a twelfth operation (12^{th} Op) 8012 may include the GJIE 206 further communicating such data to the NE 404, via a twelfth coupling 812 (as shown in FIG. 1) therebetween, and by the NE 404 to the PD 102, via the 7^{th} coupling 807. The PD 102 may use such data to populate a lobby of OCGs available for play to the given player associated with the PD 102. The populating of the lobby and other operations performed on the PD 102 are described in the DK16 App, such description is incorporated herein by reference in its entirety.

As further shown in FIG. 8 for at least one implementation of the present disclosure, a thirteenth operation (13^{th} Op) 8013 may include the GJIE 206 querying the RE 604, via a thirteenth coupling 813 (as shown in FIG. 1), for data regarding one or more rewards that the given player may have received.

As further shown in FIG. 8 for at least one implementation of the present disclosure, a fourteenth operation (14^{th} Op) 8014 may include the RE 604 communicating to the NE 404, via a fourteenth coupling 814 (as shown in FIG. 1) therebetween, and then to the PD 102 via the 7^{th} coupling 807 (as shown in FIG. 1), data responsive to the query raised during the 13^{th} operation 8013. Data retrieved pursuant to the 13^{th} operation 8013 may be non-transitorily stored in the UMS 400, the JGS 500, the PD 102, and/or elsewhere in the MJGS 100.

As further shown in FIG. 8 for at least one implementation of the present disclosure, a fifteenth operation (15^{th} Op) 8015 may include the GJIE 206 querying one or more of the JE(1-n)s 504(1-n), via a bi-directional fifteenth coupling 815 (as shown in FIG. 1), for data regarding one or more jackpots available, unavailable, currently being played, or otherwise. The data responsive to such query, as received from the JE(1-n)s 504(1-n) may be communicated to the PD 102 via the 8^{th} coupling 808 (as shown in FIG. 1) for use by the PD 102 in configuring screen displays (and the like) for presentation to a player of one or more of an OCG, a lobby, and information regarding multiple jackpots available for play, by the player, in conjunction with a given OCG. Data provided pursuant to the 15^{th} Op 8015 may be non-transitorily stored in one or more of the PD 102, PIS 200, the JGS 500, and/or elsewhere in the MJGS 100.

As further shown in FIG. 8 for at least one implementation of the present disclosure, a sixteenth operation (16^{th} Op) 8016 may include the GJIE 206 querying a bet history engine (BHE) 708 (as described hereinbelow and as instantiated by the AMS 700) for past gaming history including, but not limited to, prior OCGs played, prior jackpots, prior wagers therein, and results thereof. Responsive data may be further communicated to the player device via the 8^{th} coupling 808 (as shown in FIG. 1). Data provided pursuant to the 16^{th} Op 8016 may be non-transitorily stored in one or more of the PD 102, PIS 200, the AMS 700, and/or elsewhere in the MJGS 100.

As further shown in FIG. 8 for at least one implementation of the present disclosure, a seventeenth operation (17^{th} Op) 8017 may include the OCGE 208 communicating to the SE 406, via a seventeenth coupling 817 (as shown in FIG. 1), a request to validate a user session. When validated, a given session with the PD 102 continues. When not validated, the given session with the PD 102 may be terminated or restarted. A session validation request may occur at any time, may occur randomly, periodically, or otherwise. The initiation, maintenance and termination of sessions with a PD 102 are beyond the scope of the present disclosure and any known or later arising devices, systems, processes, computer engines, computer instructions, or the like may be utilized. Data provided pursuant to the 17^{th} Op 8017 may be non-transitorily stored in one or more of the PIS 200, the UMS 400, and/or elsewhere in the MJGS 100.

As further shown in FIG. 8 for at least one implementation of the present disclosure, an eighteenth operation (18^{th} Op) 8018 may include the OCGE 208 communicating to the PVE 408, via an eighteenth coupling 818 (as shown in FIG. 1), a request to verify a player (as then associated with a given PD 102) and one or more gaming permissions for the player. The player verification and/or permission verification may occur at any time, may occur randomly, periodically, or otherwise. It is to be appreciated that when a player is not verified and/or is not verified as having permission to participate in one or more OCGs and/or in one or more jackpots, participation of the player in the session, the OCGs, and/or the jackpot(s) may be suspended, terminated or otherwise treated by the UMS 400 until any conditions inhibiting participation of the player in the given OCG(s) and/or the given jackpot(s) are resolved. It is to be appreciated that the permissions of players with respect to one or more OCGs and/or one or more jackpots is beyond the scope of the present disclosure and any known or later arising device, systems, processes, computer engines, computer instructions, or the like may be utilized. Data provided pursuant to the 18^{th} Op 8018 may be non-transitorily stored in one or more of the PIS 200, the UMS 400, and/or elsewhere in the MJGS 100.

As further shown in FIG. 8 for at least one implementation of the present disclosure, a nineteenth operation (19^{th} Op) 8019 may include the OCGE 208 communicating to a cash engine (CE) 606 (as described herein and as instantiated by the OCGJTS 600), a request that includes one or more gameplay related activities, such as getting an update on a given player's credit balance, increasing a player's credit balance, processing a refund, initiating a debit to a player's credit balance, for example as arising from a betting action (e.g., the making of a bet and the amount betted), or other financial related aspects of a multi-jackpot game betting experience to which a given one or more bets may apply. The data responsive to such query, as received from the CE 606, may be communicated to the PD 102 via the 8^{th} coupling 808 (as shown in FIG. 1). Data provided pursuant to the 19^{th} Op 8019 may be non-transitorily stored in one or more of the PD 102, PIS 200, the JGS 500, and/or elsewhere in the MJGS 100.

As further shown in FIG. 8 for at least one implementation of the present disclosure, a twentieth operation (20^{th} Op) 8020 may include the PD 102 directly communicating a request to the JGS 500, via a twentieth coupling 820 (as shown in FIG. 1), for data regarding one or more jackpots. Such request may arise without the PD 102 requesting participation in and/or actively participating in a given OCG. For at least one implementation, data responsive to such jackpot query may be communicated to the PD 102 directly by the JGS 500 or indirectly via the GJIE 206, the 15^{th} coupling 815, and the 8^{th} coupling 808 (such couplings being shown in FIG. 1). It is to be appreciated that one or more other, direct or indirect, couplings may be utilized in other implementations of the present disclosure to communicate data between the PD and the JGS 500 and/or between other MJGS 100 components.

As further shown in FIG. 8 for at least one implementation of the present disclosure, a twenty-first operation (21^{st} Op) 8021 may include the PD 102 directly communicating a request to the OCGAS 300, via a 21^{st} coupling 821 (as shown in FIG. 1), for data regarding one or more OCGs. Such request may arise without the PD 102 requesting participation in and/or actively participating in a given OCG. For at least one implementation, data responsive to such OCG query may be communicated directly to the PD 102 by the OCGAS 300 or indirectly via the OCGE 208, the 10^{th} coupling 810, the GJIE 206, the 15^{th} coupling 815, and the 8^{th} coupling 808 (such couplings being shown in FIG. 1). It is to be appreciated that one or more other, direct or indirect, couplings may be utilized in other implementations of the present disclosure to communicate data between the PD and the OCGAS 300 and/or between other MJGS 100 components.

As further shown in FIG. 8 for at least one implementation of the present disclosure, a twenty-second (22^{nd}) Operation 8022 may include the PVE 408 communicating with the SE 406, via a 22^{nd} coupling 822 (as shown in FIG. 1). Such communications may include data requesting and/or responsive to a request by the SE 406 to verify a given player using the PVE 408. Such verification may occur at any time, including randomly, periodically, or otherwise during a session in which a given player participates in one or more of an OCG and/or one or more jackpots.

As further shown in FIG. 8 for at least one implementation of the present disclosure, a twenty-third (23^{rd}) Operation 8023 may include the GAE 410 communicating with the SE 406, via a 23^{rd} coupling 823 (as shown in FIG. 1). Such communications may include data requesting and/or response to a request to the SE 406 to authenticate a given player participating in one or more of a given OCG and/or one or more jackpots. Such authentication may occur at any time, including randomly, periodically, or otherwise during a session in which the given player participates in one or more of an OCG and/or one or more jackpots.

As further shown in FIG. 8 for at least one implementation of the present disclosure, a twenty-fourth (24^{th}) Operation 8024 may include the CE 606 communicating with the NE 404, via a 24^{th} coupling 824 (as shown in FIG. 1) and further to the PD 102, via the 7^{th} coupling 807. Such communications may include data regarding credits available to a given player, account transactions regarding the given player, and/or other credit based (as opposed to rewards) based transactions arising during participation of the given player in an OCG and/or more jackpots.

As further shown in FIG. 8 for at least one implementation of the present disclosure, a twenty-fifth (25^{th}) Operation 8025 may include the RE 604 communicating with the WLE 704, via a 25^{th} coupling 825 (as shown in FIG. 1). Such communications may include data regarding rewards granted, redeemed, or otherwise and as provided for ledgering into and/or from a given wallet ledger associated with the given player.

As further shown in FIG. 8 for at least one implementation of the present disclosure, a twenty-sixth (26^{th}) Operation 8026 may include the RE 604 communicating with the RLE 706, via a 26^{th} coupling 826 (as shown in FIG. 1). Such communications may include data regarding rewards granted, redeemed, or otherwise and as provided for ledgering into and/or from a given rewards ledger associated with the given player.

As further shown in FIG. 8 for at least one implementation of the present disclosure, a twenty-seventh (27^{th}) Operation 8027 may include the CE 606 communicating with the WLE 704, via a 27^{th} coupling 827 (as shown in FIG. 1). Such communications may include data regarding rewards credits to be credited, debited or otherwise and as provided for ledgering into and/or from a given wallet ledger associated with the given player.

As further shown in FIG. 8 for at least one implementation of the present disclosure, a twenty-eighth (28^{th}) Operation 8028 may include the CE 606 communicating with the RLE 706, via a 28^{th} coupling 828 (as shown in FIG. 1). Such communications may include data regarding rewards granted, redeemed, or otherwise and as provided for ledgering into and/or from a given rewards ledger associated with the given player.

As further shown in FIG. 8 for at least one implementation of the present disclosure, a twenty-ninth (29^{th}) Operation 8029 may include the CE 606 communicating with the JIE 612, via a 29^{th} coupling 829 (as shown in FIG. 1). Such communications may include data regarding contributions by a given player to one or more jackpots in which the given player has selected to participate. Such contribution data may be provided in conjunction with a gameplay for an OCG associated with the one or more selected jackpots.

As further shown in FIG. 8 for at least one implementation of the present disclosure, a thirtieth (30^{th}) Operation 8030 may include the CE 606 communicating with the JEE 608, via a 30^{th} coupling 830 (as shown in FIG. 1). Such communications may include data regarding one or more jackpot transactions for the one or more jackpots in which a given player has selected to participate at a given time.

As further shown in FIG. 8 for at least one implementation of the present disclosure, a thirty-first (31^{st}) Operation 8031 may include the JEE 608 communicating with the TQE 610, via a 31^{st} coupling 831 (as shown in FIG. 1). Such communications may include data regarding one or more jackpot transactions for the one or more jackpots in which a given player has selected to participate at a given time.

As further shown in FIG. 8 for at least one implementation of the present disclosure, a thirty-second (32^{nd}) Operation 8033 may include the TQE 610 communicating with the JIE 612, via a 32^{nd} coupling 832 (as shown in FIG. 1). Such communications may include data regarding one or more jackpot transactions for the one or more jackpots in which a given player has selected to participate at a given time.

As further shown in FIG. 8 for at least one implementation of the present disclosure, a thirty-third (33rd) Operation 8033 may include the CE 606 communicating with the JME 614, via a 33^{rd} coupling 833 (as shown in FIG. 1). Such communications may include data regarding one or more jackpot transactions for the one or more jackpots in which a given player has selected to participate at a given time.

As further shown in FIG. 8 for at least one implementation of the present disclosure, a thirty-fourth (34^{th}) Operation 8034 may include the JME 614 communicating with the WLE 704, via a 34^{th} coupling 834 (as shown in FIG. 1). Such communications may include data regarding one or more jackpot transactions for the one or more jackpots in which a given player has selected to participate at a given time.

As further shown in FIG. 8 for at least one implementation of the present disclosure, a thirty-fifth (35^{th}) Operation 8035 may include the JIE 612 communicating with the JME 614, via a 35^{th} coupling 835 (as shown in FIG. 1). Such communications may include data regarding one or more jackpot transactions for the one or more jackpots in which a given player has selected to participate at a given time. For at least one implementation, the data may pertain to one or more jackpot transactions for a marketing jackpot.

As further shown in FIG. 8 for at least one implementation of the present disclosure, a thirty-sixth (36^{th}) Operation 8036 may include the JIE 612 communicating with the JGS 500, via a 36^{th} coupling 836 (as shown in FIG. 1). Such communications may include data regarding one or more jackpot transactions for the one or more jackpots in which a given player has selected to participate at a given time with non-limiting examples including data regarding bets placed, requests for jackpots, player contributions to one or more jackpots, and the like.

As further shown in FIG. 8 for at least one implementation of the present disclosure, a thirty-seventh (37^{th}) Operation 8037 may include the JIE 612 communicating with the WLE 704, via a 37^{th} coupling 837 (as shown in FIG. 1). Such communications may include data regarding credits to be awarded to a given players wallet ledger in view of one or more jackpots the given player has won during a given gameplay of a given OCG.

It is to be appreciated that one or more of the above first through thirty-seventh operations described herein may occur singularly, in parallel, in the above described sequence, in another sequence, or otherwise. One or more and/or additional and/or alternative operations may be performed in accordance with an implementation of the present disclosure. Couplings for facilitating such one or more other operations may be provided. For at least one implementation, such couplings and/or operations (not shown) may include those for populating and updating leader boards for one or more OCGs and/or one or more jackpots associated with the one or more OCGS. For at least one implementation, such couplings and/or operations (not shown) may include generating marketing and/or promotional data for output to one or more PDs 102.

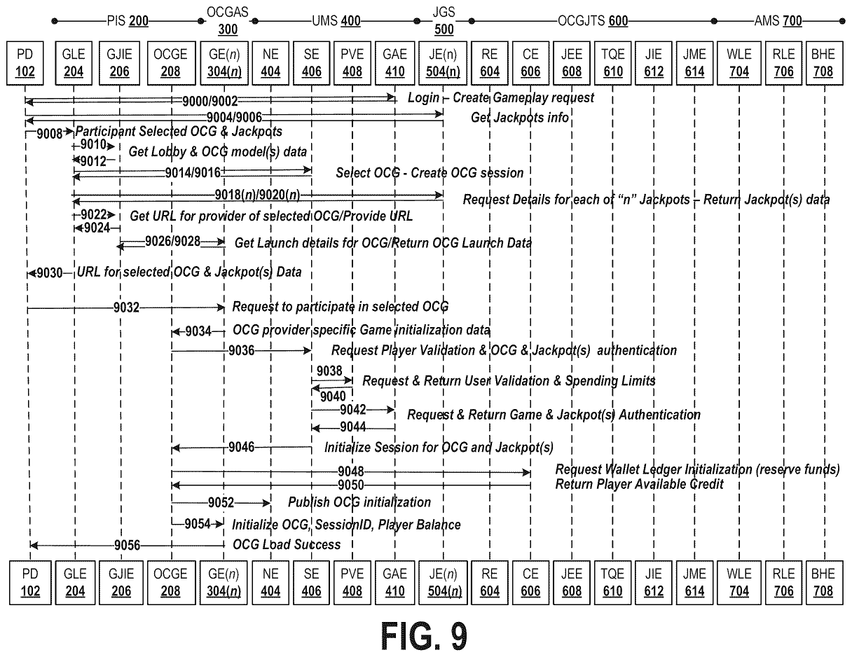

As shown in FIG. 9 and for at least one implementation of the present disclosure, a process for initializing (herein an “initialization process”) an MJG session may include per Operation 9000 a given PD 102 (on behalf of a player associated therewith having logged into a web client and/or a mobile/native application on the given PD 102) logging into the MJGS 100 and submitting a gameplay request. For at least one implementation, the gameplay request may include a request to participate in a specific OCG.

As per Operation 9002, a reply to the gameplay request may include data identifying one or more OCGs available to the player for participation therein. The one or more OCGs available may vary based on player demographics which may include, but are not limited to, the given player's current physical location as may be determined by a global positioning system (GPS) component or other location identification component provided in and/or coupled to the PD 102. It is to be appreciated that OCGs available to a given player may vary by geographic location and/or other player related demographics. Such demographics may be stored in and provided by the UMD data store as player data 418 and/or otherwise stored and provided in other components of the MJGS 100. As used herein, “player,” “user,” and “participant” are utilized interchangeably.

As per Operation 9004 and Operation 9006 and for at least one implementation, the initialization process may, respectively, include the given PD 102 requesting and receiving data regarding two or more jackpots. Such jackpot data may include opted-in jackpots, available jackpots, unavailable jackpots, wager amounts required, current jackpot balance, and the like.

As per Operation 9008 and for at least one implementation, the initialization process may include the PD 102 communicating a request to participate in a given OCG and two or more jackpots.

As per Operation 9010 and Operation 9012 and for at least one implementation, the initialization process may include, respectively, the GLE 204 requesting and receiving lobby and OCG model(s) data from the GJIE 206. The GJIE 206 may retrieve the requested OCG model data from the PIS data store 210, and/or from a given OCGAS data store 310, when such data is not already stored as gaming launch data 212, lobby/menu/user interface data 214, and/or OCG data 216.

As per Operation 9014 and Operation 9016 and for at least one implementation, the initialization process may include the GLE 204 communicating a selection of a given OCG (as selected by the PD 102) to the SE 406. Upon receiving such selection, the SE 406 creates an OCG session and returns session data to the GLE 204.

As per Operation 9018(n) and Operation 9020(n) and for at least one implementation, wherein each of Operations 9018 and 9020 are executed in series, in parallel, asynchronously and/or synchronously, the initialization process may include the GLE 204 requesting and receiving jackpot data for each of “n” jackpots (wherein for an MJG, n≥p2) to/from the JGS 500.

As per Operation 9022 and Operation 9024 and for at least one implementation, the initialization process may include the GLE 204 requesting and receiving from the OCGAS 300 for the selected OCG, a uniform resource locator (URL) at which the requested OCG may be accessed by the PD 102.

As per Operation 9026 and Operation 9028 and for at least one implementation, the initialization process may include the GJIE 206 requesting and receiving from the respective GE 304(n) for the OCGAS 300, launch details/data for the selected OCG.

As per Operation 9030 and for at least one implementation, the initialization process may include the GLE 204 communicating the URL for the selected OCG and data for two or more of the available jackpots. The communication may also include data for jackpots into which the PD 102 is opted-in, such opt-in may occur automatically, for example, when a marketing jackpot is offered and available for participation in by the given player. The communication may also include data for unavailable jackpots.

As per Operation 9032 and for at least one implementation, the initialization process may include the PD 102 communicating to the OCGAS 300 a request to participate in a selected OCG. The OCGAS 300 may provide such request to a given GE(n) 304(n) that executes gameplay for the selected OCG.

As per Operation 9034 and for at least one implementation, the initialization process may include the OCGAS 300 providing, to the OCGE 208, initialization data for the OCG selected by the player.

As per Operation 9036 and for at least one implementation, the initialization process may include the OCGE 208 requesting player validation via the SE 406, and one or more of OCG authentication and authentication of each of the two or more jackpots selected by the player.

As per Operation 9038 and Operation 9040 and for at least one implementation, the initialization process may include the SE 408 requesting and receiving (when not otherwise withheld), from the PVE 408.

As per Operation 9042 and Operation 9044 and for at least one implementation, the initialization process may include the SE 408 requesting and receiving (when not otherwise withheld), from the GAE 410, authentications for the OCG and for the two or more jackpots requested.

As per Operation 9046 and for at least one implementation, the initialization process may include the SE 406 communicating results from the player validation and OCG and jackpots authentications to the OCGE 208. Such data authorizes initialization of the session previously requested by the player, per Operation 9032.

As per Operation 9048 and Operation 9050 and for at least one implementation, the initialization process may include the OCGE 208 requesting and receiving, from the CE 606 a wallet ledger initialization. For at least one implementation, such wallet ledger initialization may include a debiting of the wallet ledger maintained for the given player and crediting of a reserve fund or the like. Such transactions ensure sufficient funds are available for the given player to participate in the selected OCG and the two or more selected jackpots. Upon performing such transactions, the CE 606 may return data indicating an amount of funds available, in the player's associated wallet ledger account and any reserve account, for the player to use in furthering gameplay (betting or the like) for the selected OCG and the two or more selected jackpots.

As per Operation 9052 and for at least one implementation, the initialization process may include the OCGE 208 publishing to the NE 404 (for further dissemination/publishing to the PD 102) initialization data for the selected OCG.

As per Operation 9054 and for at least one implementation, the initialization process may include the OCGE 208 communicating to the OCGAS 300, and thereby to the GE 304(n) for the selected OCG, data indicating that the selected OCG has been initialized, a session identifier (“sessionID”) associated therewith, and a credit balance for the player.

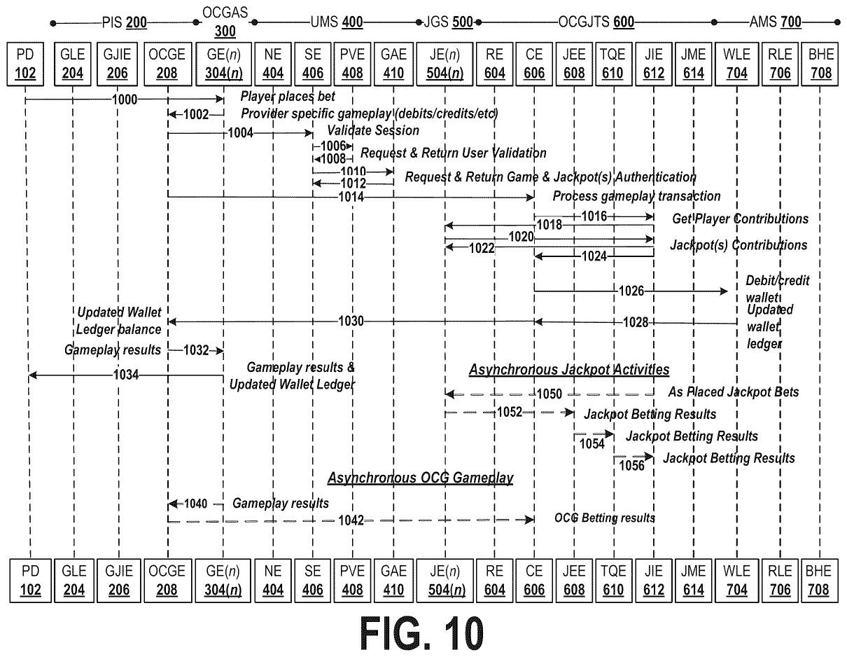

As per Operation 9056 and for at least one implementation, the initialization process may include with the OCGAS 300 communicating to the PD 102 an OCG load success message that includes data indicating that the OCG is ready for the player's participation therein, the player's credit balance, and other data relating to the playing of the OCG and the participating in the two or more jackpots by the given player. At this instance, the OCG is ready for player participation therein and a process for implementing such player process is further shown in FIG. 10.

As shown in FIG. 10 a process for processing bets and/or other activities arising during a participation of a given player in an OCG and two or more jackpots during MJG session (herein, an “MJG process”) may include, for at least one implementation of the present disclosure, per Operation 1000, receiving from the PD 102 and by the GE 304(n) for the OCG selected by the player, a bet or other gameplay related activity.

As per Operation 1002 and for at least one implementation, the MJG process may include the GE 304(n) communicating to the OCGE 208, provider specific gameplay results. Non-limiting examples of gameplay results include debits, credits, draws, or the like that may be applied against a wallet ledger account, or the like, for the given player.

As per Operation 1004 and for at least one implementation, the MJG process may include the OCGE 208 requesting a validation of the session by the SE 406.

As per Operation 1006 and Operation 1008 and for at least one implementation, the MJG process may include the SE 406 request user validation by the PVE 408. For at least one implementation, Operations 1006 and 1008 may be accomplished in a same manner as Operations 9038 and 9040.

As per Operation 1010 and Operation 1012 and for at least one implementation, the MJG process may include the SE 406 request OCG authentication and authentication of the two or more jackpots selected by the player. For at least one implementation, Operations 1010 and 1012 may be accomplished in a same manner as Operations 9042 and 9044.

As per Operation 1014 and for at least one implementation, the MJG process may include the OCGE 208 providing results of the gameplay to the CE 606. Non-limiting examples of gameplay results include debits, credits, draws, or the like that may be applied against a wallet ledger account, or the like, for the given player.

As per Operation 1016 and for at least one implementation, the MJG process may include the CE 606 requesting from the JIE 612, contributions by the player to the selected OCG (herein, the “OCG contributions” and the request being an “OCG contribution request”).

As per Operation 618 and for at least one implementation, the MJG process may include, in response to the OCG contribution request, the JIE 612 provides the OCG contributions to each of the jackpots selected, as identified by the label JE(n) 504(n).

As per Operation 1020 and for at least one implementation, the MJG process may include, respectively, the CE 606 requesting from the JIE 612, contributions by the player to each of the two or more selected jackpots (herein, each contribution singularly and collectively being a “jackpot contribution” and the request being a “jackpot contribution request”).

As per Operation 1022 and Operation 1024 and for at least one implementation, the MJG process may include, in response to the jackpot contribution request, the JIE 612 respectively communicating the jackpot contributions to each of the jackpots selected to the respective jackpot engines, as identified by the label JE(n) 504(n), and to the CE 606.

As per Operation 1026 and for at least one implementation, the MJG process may include the CE 606 requesting the WLE 704 to debit, credit, refund, or otherwise the wallet ledger 712 for the player based on the OCG contributions and/or the two or more jackpot contributions.

As per Operation 1028 and for at least one implementation, the MJG process may include the WLE 704 communicating to the CE 606 an updated wallet ledger balance for the wallet ledger 712 for the player.

As per Operation 1030 and for at least one implementation, the MJG process may include the CE 606 communicating the updated wallet ledger balance to the OCGE 208.

As per Operation 1032 and for at least one implementation, the MJG process may include the OCGE 208 communicating the gameplay results, which may include the updated wallet ledger balance, to the OCGAS 300.

As per Operation 1034 and for at least one implementation, the MJG process may include the OCGA 300 communicating the gameplay results and the updated wallet ledger balance to the PD 102.

For at least one implementation, results of OCG gameplay including, but not limited to, bet placed, bet results, gameplay results, and the like, may be determined asynchronously. Accordingly, as per Operation 1040 and for at least one implementation, the MJG process may include the OCGAS 300 communicating one or more gameplay results to the OCGE 208. As per Operation 1042 and for at least one implementation, the MJG process may include the OCGE 208 determining financial (“OCG betting”) results arising from the gameplay results and communicating the “OCG betting results” to the CE 606. The CE 606 may include the OCG betting results in the updated wallet ledger balance communicated to the OCGE 208 (per Operation 1030).

For at least one implementation, results of each jackpot gameplay including, but not limited to, wagers placed, wager results, and the like, may be determined asynchronously. Accordingly, as per Operation 1050 and for at least one implementation, the MJG process may include the TQE 610 communicating two or more, as placed jackpot bets to the JE(n) 504(n). As per Operation 1052 and for at least one implementation, the MJG process may include the JE(n) 504(n) determining, jackpot results for each of the two or more jackpots selected for the selected OCG (herein, the “jackpot betting results”) and communicating the jackpot betting results to the JEE 608. As per Operation 1054 and for at least one implementation, the MJG process may include the JEE 608 further communicating the jackpot betting results to the TQE 608. As per Operation 1056 and for at least one implementation, the MJG process may include the TQE 608 further communicating the jackpot betting results to the JIE 612. The JIE 612 may use the jackpot betting results to determine whether to debit or credit jackpot contributions, as communicated per Operations 1022 and 1024 and as further communicated to The WLE 614, as per Operation 1026.

Accordingly, it is to be appreciated that the MJGS 100 and the operations performed by the components thereof, provide devices, systems and processes by which multiple jackpots can be associated with one selected OCG, from a plurality of OCGs available for participation therein by a given player at a given time and at a given location. For at least one implementation, ten (10) or more jackpots may be associated with the selected OCG and jackpot results thereof separately and independently determined, tracked, recorded and/otherwise processed while maintaining an MJGS 100 which is robust (in terms of data integrity) and provides communicative separations between PDs 102, OCGASs 300, and AMS 700 and other backend components and functions of the MJGS 100.

The operations identified in FIGS. 8-10 are provided herein for illustrative purposes, are not intended to be limiting, and may be performed (if at all) in any order, sequence, combination, permutation, or otherwise as may be applicable to a given implementation of the present disclosure.

Although various implementations have been described above with a degree of particularity, or with reference to one or more individual implementations, those skilled in the art could make alterations to the disclosed implementations without departing from the spirit or scope of the present disclosure. The use of the terms “approximately” or “substantially” means that a value of an element has a parameter that is expected to be close to a stated value or position. As is well known in the art, there may be minor variations that prevent the values from being as stated. Accordingly, anticipated variances, such as 10% differences, are reasonable variances that a person having ordinary skill in the art would expect and know are acceptable relative to a stated or ideal goal for one or more implementations of the present disclosure. It is also to be appreciated that the terms “top” and “bottom,” “left” and “right,” “up” or “down,” “first,” “second,” “next,” “last,” “before,” “after,” and other similar terms are used for description and ease of reference purposes and are not intended to be limiting to any orientation or configuration of any elements or sequences of operations for the various implementations of the present disclosure. Further, the terms “coupled,” “connected” or otherwise are not intended to limit such interactions and communication of signals between two or more devices, systems, components or otherwise to direct interactions; indirect couplings and connections may also occur. Further, the terms “and” and “or” are not intended to be used in a limiting or expansive nature and cover any possible range of combinations of elements and operations of an implementation of the present disclosure. Other implementations are therefore contemplated. It is intended that matter contained in the above description and shown in the accompanying drawings be interpreted as illustrative of implementations and not limiting. Changes in detail or structure may be made without departing from the basic elements of the present disclosure as described in the following claims.

What is claimed is:

1. A multi-jackpot game system (MJGS) comprising:
a player interface service (PIS);
a user management service (UMS);
a jackpot gamification service (JGS);
an online casino game and jackpot transaction service (OCGJTS); and
an account management service (AMS);
wherein a given player device, utilized by a given player, is communicatively coupled to the PIS, an online casino gaming aggregator services (OCGAS), the JGS, and the UMS;
wherein the PIS is further respectively communicatively coupled to the OCGAS, the JGS, the OCGJTS, the UMS, and the AMS;
wherein the UMS is further respectively communicatively coupled to the OCGJTS;
wherein the JGS is further communicatively coupled to the OCGJTS;
wherein the OCGJTS is further communicatively coupled to the AMS;
wherein the PIS comprises:
a PIS processor;
a non-transitory PIS data store, coupled to the PIS processor, non-transitorily storing PIS computer instructions which, when executed by the PIS processor, instantiate:
a gaming launch engine (GLE) that performs gaming launch operations (GLO) including:
launching a given online casino game (OCG) on the given player device; and
facilitating retrieval and updating of data specific to the given OCG;
a gaming/jackpot interface engine (GJIE) that performs gaming/jackpot interface operations (GJIO) including:
managing configuration of the given OCG; and
presenting a jackpot lobby on the given player device;
wherein the jackpot lobby identifies at least two available jackpots available for selection by the given player; and
an online casino gamine engine (OCGE) that performs OCG operations (OCGO) including:
communicating gameplay requests to and from the OCGAS for the given OCG.

2. The MJGS of claim 1,
wherein at least one of the at least two available jackpots are available, to the given player device, while the given player device participates in at least one of the given OCG and another OCG.

3. The MJGS of claim 2,
wherein the GLO further include:
identifying one or more OGCs available for the given player to participate in based on a current location of the given player; and
wherein the GJIO further include:
receiving a request, from the given player device, for jackpot data for at least one of the at least two available jackpots; and
receiving a request, from the given player device, to participate in the given OCG and select two or more of the at least two available jackpots.

4. The MJGS of claim 1,
wherein the UMS comprises:
a UMS processor; and
a non-transitory UMS data store, coupled to the UMS processor, non-transitorily storing UMS computer instructions which, when executed by the UMS processor instantiate:
a notification engine (NE) that performs NE operations (NEO) including:
communicating data provided by one or more of the PIS, the JGS, the OCGJTS, or the AMS to the given player device.

5. The MJGS of claim 4,
wherein the UMS computer instructions, when executed by the UMS processor, further instantiate:
a session engine (SE) that performs SE operations (SEO) including:
managing a given gaming session for the given OCG; and
generating a user interface, for presentation to the given player device by a gaming/jackpot interface engine instantiated by a PIS processor; and
wherein the user interface facilitates at least one of a creation, a validation, an extension, and a termination of the given gaming session by the given player device.

6. The MJGS of claim 4,
wherein the UMS computer instructions, when executed by the UMS processor, further instantiate:
a player validator engine (PVE) that performs PVE operations (PVEO) including:
managing participation by the given player device in the given gaming session.

7. The MJGS of claim 4,
wherein the UMS computer instructions, when executed by the UMS processor, further instantiate:
a gameplay authenticator engine (GAE) that performs GAE operations (GAEO) including:
monitoring gameplay actions for the given OCG;
authenticating the gameplay actions;
monitoring jackpot actions requested by the given player device with respect to at least one selected jackpot of the at least two available jackpots; and
authenticating the jackpot actions.

8. The MJGS of claim 7,
wherein the authenticating of the jackpot actions is performed by the GAE based on gaming rules specified for the at least one selected jackpot.

9. The MJGS of claim 1,
wherein the JGS comprises:
a JGS processor; and
a non-transitory JGS data store, coupled to the JGS processor, non-transitorily storing JGS computer instructions which, when executed by the JGS processor, instantiate:
a jackpot gaming engine (JGE) for the at least two available jackpots;
wherein the JGEs perform jackpot operations (JO) including:
receiving, from the PIS, an acceptance of a given jackpot selected, by the given player device, from the at least two available jackpots;
wherein the acceptance includes a plurality of wagers placed by the given player device including:
a first wager for a gameplay turn in the given OCG;
a second wager for a first jackpot of the at least two available jackpots; and
a third wager for a second jackpot of the at least two available jackpots.

10. The MJGS of claim 1,
wherein the OCGJTS comprises:
an OCGJTS processor; and
a non-transitory OCGJTS data store, coupled to the OCGJTS processor, non-transitorily storing OCGJTS computer instructions which, when executed by the OCGJTS processor, instantiate:
a rewards engine (RE) that performs RE operations (REO) including:
processing a reward arising from gameplay for at least one of the given OCG and at least one of the at least two available jackpots; and
a credit engine (CE) that performs CE operations (CEO) including:
processing a credit transaction arising from the gameplay for at least one of the given OCG and at least one of the at least two available jackpots.

11. The MJGS of claim 1,
wherein the OCGJTS comprises:
an OCGJTS processor; and
a non-transitory OCGJTS data store, coupled to the OCGJTS processor, non-transitorily storing OCGJTS computers instructions which, when executed by the OCGJTS processor, instantiate:
a jackpot event engine (JEE) that performs JEE operations (JEEO) including:
storing data regarding a jackpot event for at least one of the at least two available jackpots; and
a transaction queuing engine (TQE) that performs TQE operations (TQEO) including:
receiving jackpot event data indicative of a jackpot event for at least one of the at least two available jackpots; and
using an ordered data structure to manage processing of the jackpot event data when the jackpot event data is received in an asynchronous order.

12. The MJGS of claim 1,
wherein the OCGJTS comprises:
an OCGJTS processor; and
a non-transitory OCGJTS data store, coupled to the OCGJTS processor, non-transitorily storing OCGJTS computers instructions which, when executed by the OCGJTS processor, instantiate:
a jackpot integration engine (JIE) that performs JIE operations (JIEO) including:
integrating an online casino platform with a jackpot platform;
wherein the online casino platform facilitates gameplay, by the given player via the given player device, for the given OCG; and
wherein the jackpot platform facilitates presentation of the at least two available jackpots to the given player via the given player device; and
negotiating an authentication token for use in the given OCG and at least one of the at least two available jackpots.

13. The MJGS of claim 12,
wherein the OCGJTS computer instructions, when executed by the OCGJTS processor, further instantiate:
a jackpot messaging engine (JME) that performs JME operations (JMEO) including:
communicating an OCG result arising from gameplay for the given OCG to the JGS;
wherein the JGS determines whether the OCG result qualifies as a winning gameplay for a selected jackpot of the at least two available jackpots in which the given player has selected to participate;
receiving a jackpot won notification from the JGS when the given player device has won the selected jackpot; and
communicating the jackpot won notification to the AMS.

14. The MGJS of claim 1,
wherein the AMS comprises:
an AMS processor; and
a non-transitory AMS data store, coupled to the AMS processor, non-transitorily storing AMS computer instructions which, when executed by the AMS processor, instantiate:
a wallet ledger engine (WLE) that maintains an account record for the given player;
a rewards ledger engine (RLE) that maintains a reward record for the given player; and
a bet history engine (BHE) that maintains a bet history for the given player that includes data regarding bets placed and results thereof for any OCGs and for any jackpots in which the given player has participated.

15. A multi-jackpot game system (MJGS) comprising:
a player interface service (PIS);
a user management service (UMS);
a jackpot gamification service (JGS);
an online casino game and jackpot transaction service (OCGJTS); and
an account management service (AMS);
wherein the PIS facilitates presentation, on a given player device, of data regarding an online casino game (OCG) and at least two or more available jackpots associated with the OCG;
wherein the UMS facilitates communication of additional data from the JGS, OCGJTS and AMS to the given player device;
wherein the JGS facilitates gameplay regarding the at least two or more available jackpots;
wherein the OCGJTS facilitates record keeping based on results arising from OCG gameplay and selected jackpot gameplay; and
wherein the AMS facilitates accounting for gameplay results for the OCG gameplay and selected jackpot gameplay.

16. The MJGS of claim 15, wherein the PIS comprises:
a gaming launch engine (GLE) that performs gaming launch operations (GLO) including:
launching a given online casino game (OCG) on the given player device; and
facilitating retrieval and updating of data specific to the given OCG;
a gaming/jackpot interface engine (GJIE) that performs gaming/jackpot interface operations (GJIO) including:
managing configuration of the given OCG; and
presenting a jackpot lobby on the given player device;
wherein the jackpot lobby identifies at least two available jackpots for selection by the given player; and
an online casino gamine engine (OCGE) that performs OCG operations (OCGO) including:
communicating gameplay requests to and from the OCGJTS for the given OCG.

17. The MJGS of claim 15,
wherein the JGS comprises:
a jackpot gaming engine (JGE) that is instantiated by a JGS processor for the at least two available jackpots;
wherein each of the JGEs perform jackpot operations (JO) including:
receiving, from the PIS, an acceptance of a given jackpot selected, by the given player device, from the at least two available jackpots;
wherein the acceptance includes a plurality of wagers placed by the given player device including:
a first wager for a gameplay turn in the given OCG;
a second wager for a first jackpot of the at least two available jackpots; and
a third wager for a second jackpot of the at least two available jackpots.

18. The MJGS of claim 15,
wherein the OCGJTS comprises:
a jackpot integration engine (JIE) that integrates an online casino platform with a jackpot platform;
wherein the online casino platform facilitates gameplay, by the given player via the given player device, for the given OCG; and
wherein the jackpot platform facilitates presentation of the at least two available jackpots to the given player via the given player device.

19. The MJGS of claim 15,
wherein the OCGJTS comprises:
a jackpot event engine (JEE) that stores data regarding a jackpot event for at least one of the at least two available jackpots; and
a transaction queuing engine (TQE) that receives jackpot event data indicative of a jackpot event for at least one of the at least two available jackpots and utilizes an ordered data structure to manage processing of the jackpot event data when the jackpot event data is received in an asynchronous order.

20. The MJGS of claim 15,
wherein the AMS comprises:
a wallet ledger engine (WLE) that maintains an account record for the given player;
a rewards ledger engine (RLE) that maintains a reward record for the given player; and
a bet history engine (BHE) maintains a bet history for the given player;
wherein the bet history includes data regarding bets placed and results thereof for any OCGs and for any jackpots in which the given player has participated.
